(19) United States
(12) Patent Application Publication
(10) Pub. No.: US 2023/0030312 A1
(43) Pub. Date: Feb. 2, 2023

(54) NEGATIVE ELECTRODE ACTIVE MATERIAL FOR LITHIUM SECONDARY BATTERY AND METHOD FOR PRODUCING THE SAME, NEGATIVE ELECTRODE FOR LITHIUM SECONDARY BATTERY, AND LITHIUM SECONDARY BATTERY

(71) Applicant: EoCell Limited, Hong Kong (CN)

(72) Inventors: BongChull KIM, San Jose, CA (US); Heesang JEON, San Jose, CA (US)

(21) Appl. No.: 17/373,801

(22) Filed: Jul. 13, 2021

(51) Int. Cl. H01M 4/587; H01M 10/0525; C01B 32/21

(52) U.S. Cl. CPC H01M 4/587; H01M 10/0525; C01B 32/21; H01M 2004/027

(57) ABSTRACT

In an embodiment, a negative electrode active material includes a particulate silicon-carbon nanocomposite (SCN) material composition including SCN particles that each have: a graphite particle core having an irregular morphology; a plurality of silicon nanostructures distributed around the graphite particle core, including silicon nanostructures exhibiting plate-like morphologies and which have an outer layer that includes SiOₓ; and an amorphous carbon layer or matrix that encapsulates the silicon nanostructures and at least portions of the irregular morphology graphite particle core, wherein the SCN material composition has a wt % material composition ratio of: (a) 20-60 wt % of graphite particle cores; (b) 35-60 wt % silicon nanostructures; and (c) 15-30 wt % amorphous carbon, wherein the combination of each such wt % totals to 100%. The negative electrode active material can exhibit an oxide content of less than 8 wt % provided by silicon nanostructure SiOₓ layers.

### TECHNICAL FIELD

Aspects of the present disclosure relate to: (1) a negative electrode active material that includes a silicon carbon nanocomposite (SCN) material composition having an elevated silicon content, wherein at least some individual SCN particles are formed as: (a) an irregular morphology graphite particle core, (b) at least some plate-like morphology silicon nanostructures surrounding the irregular morphology graphite particle core, and (c) an amorphous carbon layer surrounding the silicon nanostructures and the irregular morphology graphite particle core; (2) a production process for the same, which can include surface modification of silicon nanostructures to carry or contain particular oxide compounds (e.g., including a non-silicon metal oxide and/or a mixed silicon-non-silicon metal oxide); and (3) the use of such a negative electrode active material in an anode material composition or anode electrode for an electrochemical cell or a battery structure, e.g., a lithium secondary battery.

### BACKGROUND

Rechargeable lithium ion batteries have become the dominant rechargeable power sources in many types of commercial devices e.g., small/portable electronic devices, and in the battery pack system for electrical vehicles. They utilize an organic electrolyte solution, and thus have twice the discharge voltage of conventional batteries that utilize alkaline aqueous electrolyte solutions.

With respect to cathode materials or positive active materials for rechargeable lithium ion batteries, lithium transition element composite oxides that are capable of intercalating lithium, such as LiCoO₂, LiMn₂O₄, and LiNi₁₋ₓCoₓO₂ (0<x<1) have been researched, among others.

With respect to anode materials or negative active materials, various carbon-based materials capable of intercalating and deintercalating lithium ions, such as such as artificial graphite, natural graphite, and hard carbon, have been used. However, due to the need for stability and significantly enhanced capacity, efforts have recently been directed to anode materials based upon or containing silicon. Further improvements are needed in order to produce silicon based or silicon containing anode materials having reduced internal material stresses, e.g., associated with intercalation; sufficiently high capacity; and good cycle life retention to be useful across a wide or very wide variety of systems or devices that utilize rechargeable lithium ion batteries as their power source(s).

### SUMMARY

In accordance with an embodiment of the present disclosure, a silicon-carbon nanocomposite (SCN) material composition includes SCN particles, including SCN particles that each comprise: a graphite particle core, each graphite particle core having an irregular morphology characterized by a plurality of outer surfaces including a plate-type outer surface; a plurality of silicon nanostructures distributed around the irregular morphology graphite particle core, including silicon nanostructures exhibiting plate-like morphologies and which have an outer layer that includes SiOₓ; and an amorphous carbon layer or matrix that encapsulates the silicon nanostructures and at least portions of the irregular morphology graphite particle core.

The SCN particles can have crystalline material structures therein that exhibit an X-ray diffraction (XRD) pattern in which: (a) three highest peaks corresponding to silicon are at positions of 2θ=28.3°±0.5°, 2θ=47.2°±0.5°, 2θ=56.1°±0.5°; and (b) three highest peaks corresponding to graphite are at positions of 2θ=26.4°±0.5°, 2θ=44.5°±0.5°, and 2θ=54.5°±0.5°, as obtained by way of a powder XRD device that uses CuKα1 rays.

The SCN particles can have crystalline material structures therein that exhibit an X-ray diffraction (XRD) pattern in which a ratio of (a) an XRD peak with a highest integrated intensity corresponding to silicon at a position of 2θ=28.3°±0.5° to (b) an XRD peak with a highest integrated intensity corresponding to graphite at a position of 2θ=26.4°±0.5° is between approximately 0.95-8.65, as obtained by way of a powder XRD device that uses CuKα1 rays.

The SCN particles can have crystalline material structures therein that exhibit an XRD pattern in which a ratio of (a) an XRD peak with a highest integrated intensity corresponding to silicon at a position of 2θ=28.3°±0.5° to (b) an XRD peak with a highest integrated intensity corresponding to graphite at a position of 2θ=26.4°±0.5° is between approximately 0.95-8.65, and wherein the SCN particles have a discharge capacity between approximately 1300-2000 milliamp-hours per gram (mAh/g).

The SCN particles can exhibit a wt % material composition ratio of approximately: (a) 4-45 wt % of graphite particle cores; (b) 35-76 wt % silicon nanostructures, including at least some silicon nanostructures having an outer layer including SiOₓ; and (c) 15-45 wt % amorphous carbon, wherein the wt % of graphite particle cores, the wt % of silicon nanostructures, and the wt % of amorphous carbon totals to 100%.

The SCN particles including silicon nanostructures can have outer oxide layers that include SiOₓ, and which collectively providing the SCN material composition with an oxygen content less than or equal to 10 wt %. In accordance with particular aspects of the present disclosure, such silicon nanostructures can have outer oxide layers including a non-silicon metal oxide compound of the form M_{y}O_{z} and/or a mixed silicon-non-silicon metal oxide compound of the form SiₓM_{y}O_{z}, wherein M designates a non-silicon metal element

The graphite particle cores within the SCN material composition can have an average specific surface area between 1.5-8 square meters per gram (m²/g). The graphite particle cores within the SCN material composition can have an average specific surface area less than or equal to 3.5 m²/g±1.5. The graphite particle cores in the SCN material composition can be artificial graphite particles having a plate-type morphology and a median particle size of 6-18 micrometers (μm) or less.

In accordance with some aspects of the present disclosure, for each silicon nanostructure exhibiting a plate-like morphology: (a) the silicon nanostructure has a median particle size D50 between approximately 50-300 nanometers (nm); (b) with respect to three orthogonal axes relative to which the silicon nanostructure is positioned or aligned: a first axis extends along a largest or longest physical span or spatial extent of the silicon nanostructure that establishes the silicon nanostructure's length; a second axis orthogonal to the first axis extends along a next largest physical span or spatial extent of the silicon nano structure that establishes the silicon nanostructure's width; and a third axis orthogonal to the first and second axes extends along a smallest physical span or spatial extent of the silicon nanostructure that establishes the silicon nanostructure's thickness; and (c) a mean aspect ratio of each silicon nanostructure defined by a ratio of the thickness of the silicon nanostructure to the length of the silicon nanostructure within a cross sectional plane through the amorphous carbon layer or matrix is between 0.20-0.60. The silicon nanostructures can include of nanosilicon grains exhibiting an average size or diameter of 10-50 nm.

In accordance with an aspect of the present disclosure, a lithium ion (Li-ion) battery structure includes an anode electrode carrying the SCN material composition of claim 1. The Li-ion battery structure can include a cathode electrode; a liquid or solid state electrolyte; and a pouch, prismatic, or cylindrical structure in which the anode electrode, the cathode electrode, and the electrolyte reside.

The SCN material of the anode electrode can include approximately 3-50 wt % SCN particles mixed with approximately 50-97 wt % additional graphite particles by mass, to give an SCN material of 100 wt %.

The SCN material of the anode electrode can include 5-20% SCN particles mixed with approximately 80-98% additional graphite particles by mass.

The SCN material of the anode electrode can include 100% SCN particles.

The SCN material of the anode electrode can include approximately 60-90% SCN particles mixed with approximately 40-10% additional carbon-based particles by mass.

In accordance with an aspect of the present disclosure, a method or process for producing a particulate silicon-carbon nanocomposite (SCN) material includes: providing or producing a first powder comprising primary graphite particles having nanoscale silicon particles on outer surfaces thereof; subjecting the first powder to a temperature-controlled high shear mixing procedure to produce a second powder comprising primary graphite particles carrying silicon nanostructures distributed on the outer surfaces thereof, wherein the silicon nanostructures include a multiplicity of silicon nanostructures having plate-like morphologies; and performing at least two iterations of: distributing a source of amorphous carbon over or across the primary graphite particles carrying silicon nanostructures in the second powder; performing a set of carbonization procedures upon the primary graphite particles carrying silicon nanostructures in the second powder and having the source of amorphous carbon distributed thereover or thereacross to produce SCN particles; and deagglomerating the SCN particles produced by way of the set of carbonization procedures to produce SCN particles having particle sizes that satisfy or meet a particle size criterion.

The source of amorphous carbon can include or be pitch. For instance, the source of amorphous carbon can include or be solid pitch particles.

In accordance with particular aspects of the present disclosure, providing or producing the first powder includes: producing or providing nanoscale silicon particles; applying or combining a non-silicon metalorganic compound to the nanoscale silicon particles; and combining the nanoscale silicon particles to which the non-silicon metalorganic compound has been applied with the primary graphite particles. The process can further include transforming the non-silicon metalorganic compound to a non-silicon metal oxide composition and/or a mixed silicon-non-silicon metal oxide compound by way of the set of carbonization procedures.

The set of carbonization procedures can be performed at a temperature between 700-1000° C. (e.g., in a furnace).

The set of carbonization procedures can include a first carbonization procedure performed at a first temperature during a first time interval, followed by a second carbonization procedure performed at a second temperature higher than the first temperature during a second time interval.

In accordance with an aspect of the present disclosure, a method or process for producing a negative electrode active material includes: providing nanoscale silicon particles that were produced under a controlled atmosphere which limited the formation of SiOₓ on the outer surfaces of the nanoscale silicon particles; applying a non-silicon metalorganic compound containing a non-silicon metal element M to outer surfaces of the nanoscale silicon particles; associating the nanoscale silicon particles carrying the non-silicon metalorganic compound on their outer surfaces with a carbon source; and subjecting the nanoscale silicon particles carrying the non-silicon metalorganic compound on their outer surfaces and associated with the carbon source to a set of thermal procedures by which the non-silicon metalorganic compound is converted to a non-silicon metal oxide, M_{y}O_{z}, and/or a mixed silicon-non-silicon metal oxide, SiₓM_{y}O_{Z}, on the outer surfaces of the nanoscale silicon particles. Such a process can further include producing a negative electrode that includes the nanoscale silicon particles carrying the non-silicon metal oxide, M_{y}O_{z}, and/or the mixed silicon-non-silicon metal oxide, SiₓM_{y}O_{z}, on their outer surfaces.

### BRIEF DESCRIPTION OF THE DRAWINGS

FIG. 1 is a schematic illustration of a silicon carbon nanocomposite (SCN) particle in accordance with a representative embodiment of the present disclosure.

FIGS. 2A-2B are a flow diagram of a process for producing a particulate silicon carbon nanocomposite (SCN) material, characterizing and testing aspects of the particulate SCN material, and using the particulate SCN material as an anode material or negative active material in an anode structure in accordance with an embodiment of the present disclosure.

FIGS. 3A and 3B are scanning electron microscope (SEM) photographs taken in backscatter emission (BSE) mode showing a cross-sectional view and a plane view, respectively, of example SCN (ESCN) particles produced in accordance with an embodiment of the present disclosure.

FIGS. 4A and 4B show low magnification and high magnification transmission electron microscopy (TEM) images, respectively, of samples of silicon nanostructures embedded in an amorphous carbon matrix or layer of an ESCN particle.

FIG. 5 is an X-Ray Diffraction (XRD) Rietveld analysis plot directed to quantitatively characterizing crystalline materials in ESCN particles produced in accordance with an embodiment of the present disclosure, where this plot indicates representative Si(111) and graphite(002) XRD peak intensities thereof.

FIG. 6A is a graph showing capacity retention versus charge-discharge cycle number for the graphite-blended SiOₓ-based lithium ion coin half cells and the graphite-blended ESCN-based lithium ion coin half cells, across 49 successively repeated charge-discharge cycles and terminating with a 50th full charge.

FIG. 6B shows side-by-side photographs of a disassembled graphite-blended ESCN-based anode structure and a disassembled SiOₓ-based anode structure after the 50th full charging, corresponding to the results shown in FIG. 6A.

FIG. 7 shows a capacity retention cycle life curve across a total of 1512 charge-discharge cycles for representative 3.5 Ah pouch cells having ESCN based anode structures in accordance with an embodiment of the present disclosure.

### DETAILED DESCRIPTION

Throughout this specification, unless the context stipulates or requires otherwise, any use of the word “comprise,” and variations such as “comprises” and “comprising,” imply the inclusion of a stated integer or step or group of elements or steps but not the exclusion of any other integer or step or group of elements or steps.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions , “Chapter 11: Properties of Finite Sets” (e.g., as indicated on p. 140), by Peter J. Eccles, Cambridge University Press (1998)). Thus, a set includes at least one element. In general, an element of a set can include or be one or more portions of a structure, an object, a process, a composition, a physical parameter, or a value depending upon the type of set under consideration.

Herein, reference to one or more embodiments, e.g., as various embodiments, many embodiments, several embodiments, multiple embodiments, some embodiments, certain embodiments, particular embodiments, specific embodiments, or a number of embodiments, need not or does not mean or imply all embodiments.

The FIGs. included herewith show aspects of non-limiting representative embodiments in accordance with the present disclosure, and particular structures or features shown in the FIGs. may not be shown to scale or precisely to scale relative to each other. The depiction of a given element or consideration or use of a particular element number in a particular FIG. or a reference thereto in corresponding descriptive material can encompass the same, an equivalent, an analogous, categorically analogous, or similar element or element number identified in another FIG. or descriptive material associated therewith. The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” can indicate a percentage greater than or equal to 90%, for instance, 92.5%, 95%, 97.5%, 98%, 98.5%, 99%, 99.5%, or 100%.

### Overview

Various embodiments in accordance with the present disclosure are directed to a negative electrode active material for lithium secondary batteries; a process for producing the same; a negative electrode for lithium secondary batteries; and lithium secondary battery structures. In accordance with various embodiments of the present disclosure, a negative electrode active material for lithium secondary batteries includes a silicon carbon nanocomposite (SCN) material or material composition, which can be defined as a material or material composition that carries, includes, or is formed of SCN particles in accordance with an embodiment of the present disclosure. Such SCN particles have an enhanced or increased (e.g., significantly, greatly, or dramatically increased) silicon content compared to prior SCN particles, while remaining physically robust with respect to lithiation-delithiation cycles. Particulate SCN material can be defined as a material in particle form that includes SCN particles, or which is formed of SCN particles (e.g., a particulate material that includes, consists essentially of, or consists of SCN particles).

SCN particles include or are formed of underlying, inner/innermost, or core graphite particles (e.g., individual core graphite particles, or possibly small aggregates of core graphite particles/minimally or negligibly aggregated core graphite particles) that are at least partially surrounded, covered, or overlaid with an amorphous carbon layer or matrix having silicon nanostructures and/or nano-powders supported, carried, embedded, or encapsulated therein. The core graphite particles can aid or enhance the structural integrity of the SCN particles (e.g., by way of reducing brittleness/increasing structural resiliency), for instance, by reducing an amount of (typically more brittle) amorphous carbon in the SCN particles. The silicon nanostructures and/or silicon nano-powders typically exhibit, are organized as, or are formed of silicon nano-grains. Additionally, in accordance with multiple embodiments of the present disclosure the silicon nanostructures and/or nano-powders (e.g., the outer surfaces of the silicon nanostructures) and hence the SCN particles carrying or containing the silicon nanostructures and/or nano-powders, can be doped and/or surface modified by way of materials, chemicals, or chemical species containing one or more non-silicon metal elements during the manufacture thereof (e.g., during an SCN particle manufacturing process, prior to the fabrication of an anode electrode that carries the SCN particles). For purpose of simplicity and brevity, silicon nanostructures and silicon nano-powders are referred to herein as silicon nanostructures.

Depending upon embodiment details, the core graphite particles can include or be unitary or separate/isolated individual pieces or granules of graphite in particulate form, and/or possibly at least some aggregates of particulate graphite (e.g., where such aggregates, if present, typically contain few or very few individual core graphite particles, for instance, no more than 3-10 or 3-7 individual core graphite particles, or typically 5 or fewer or 3 or fewer core graphite particles, and larger aggregates of core graphite particles can be avoided, not formed, or excluded). In multiple embodiments, the core graphite particles are predominantly or overwhelmingly unitary pieces or granules of graphite in particulate form, with very few aggregates thereof. For purpose of simplicity and brevity, core graphite particles that exist in unitary or separate/isolated form (i.e., not as particulate aggregates) as well as core graphite particles that exist in aggregate form (i.e., not as unitary or separate/isolated individual graphite particles or granules) are referred to herein as core graphite particles, or graphite particle cores. In various embodiments, the core graphite particles include or are artificial graphite particles having an irregular morphology characterized by a plurality of outer surfaces including at least one plate-type outer surface (e.g., the core graphite particles can include or be artificial graphite particles having plate-type morphologies, such that they have a set or plurality of plate-type outer surfaces).

For a given SCN particle, its amorphous carbon layer contains non-spheroidal silicon nanostructures, (e.g., many or mostly/primarily non-spheroidal silicon nanostructures; for instance, in several embodiments, fewer than approximately 25-70%, or possibly fewer than approximately 35-65% of the silicon nanostructures carried by SCN particles produced in a manner described herein are spheroidal). More particularly, within the amorphous carbon layer at least some of the silicon nanostructures, and in several embodiments many or the majority or nearly or essentially all of the silicon nanostructures exhibit plate-like morphologies, e.g., the silicon nanostructures typically exhibit plate-like profiles or shapes. For instance, a given or typical SCN particle under consideration typically carries a multiplicity of silicon nanostructures having plate-like morphologies.

Still more particularly, for each silicon nanostructure exhibiting a plate-like morphology, with respect to three orthogonal axes relative to which the silicon nanostructure is positioned or aligned, a first axis can be defined extending along a largest or longest physical span or spatial extent of the silicon nanostructure that establishes the silicon nanostructure's approximate length (hereafter “length” for purpose of simplicity and brevity); a second axis (orthogonal to the first axis) can be defined extending along a next largest, smaller but approximately equivalent, or approximately equivalent physical span or spatial extent of the silicon nanostructure that establishes the silicon nanostructure's approximate width (hereafter “width” for purpose of simplicity and brevity); and a third axis (orthogonal to the first and second axes) can be defined extending along a smallest physical span or spatial extent of the silicon nanostructure that establishes the silicon nanostructure's approximate thickness (hereafter “thickness” for purpose of simplicity and brevity). For various silicon nanostructures having plate-like morphologies, the thickness of each silicon nanostructure can be or typically is less or significantly less than the silicon nanostructure's length, e.g., by approximately 10-90% or more, or typically approximately 20-80% or more. With respect to general or approximate a three dimensional (3D) geometric shape or profile, each such silicon nanostructure can have a first generally planar two dimensional (2D) surface, e.g., which can be defined as a first surface, defined the silicon nanostructure's length and width; and an opposing second generally planar 2D surface, e.g., which can be defined as a second surface. The first surface is separated from the second surface by the silicon nanostructure's thickness, which in some embodiments can at least somewhat vary across the silicon nanostructure's length and/or width.

Silicon nanostructures exhibiting plate-like morphologies within the amorphous carbon layer can at least partially or generally physically resemble or correspond to sheet-like structures (e.g., nanosheets), tile-like nanostructures (e.g., nanotiles), flake-like nanostructures (e.g., nanoflakes), bar-like structures (e.g., nanobars), rod-like structures (e.g., nanorods), disc-like structures (e.g., nanodiscs), and/or other type of structures such as block-like structures (e.g., nanoblocks).

In various embodiments, the silicon nanostructures have a median particle size D50 between approximately 50-300 nanometers (nm); and with respect to three orthogonal axes relative to which the silicon nanostructure is positioned or aligned: a first axis extends along a largest or longest physical span or spatial extent of the silicon nanostructure that establishes the silicon nanostructure's length; a second axis orthogonal to the first axis extends along a next largest physical span or spatial extent of the silicon nano structure that establishes the silicon nanostructure's width; and a third axis orthogonal to the first and second axes extends along a smallest physical span or spatial extent of the silicon nanostructure that establishes the silicon nanostructure's thickness. Moreover, in various embodiments a mean aspect ratio of each silicon nanostructure defined by a ratio of the thickness of the silicon nanostructure to the length of the silicon nanostructure within a cross sectional plane through the amorphous carbon layer or matrix is between 0.20-0.60.

In at least some though not necessarily all embodiments, the core graphite particles carry such plate-like silicon nanostructures essentially entirely or only around and/or on their outer surfaces, such that the plate-like silicon nanostructures are essentially absent or are entirely excluded from pores within the core graphite particles.

Multiple embodiments in accordance with the present disclosure are also directed to a fabrication process for producing such an SCN material.

Further embodiments in accordance with the present disclosure are directed to anode structures or anodes carrying such an SCN material, which are suitable for use in electrochemical cells or battery structures such as lithium ion batteries. For instance, a lithium ion battery structure can include an anode electrode including or carrying an SCN material composition; a cathode electrode; a liquid or solid state electrolyte; and a pouch, prismatic, or cylindrical structure in which the anode electrode, the cathode electrode, and the electrolyte reside. In some embodiments, the SCN material composition of the anode electrode can include approximately 3-50 wt % SCN particles mixed with approximately 50-97 wt % additional graphite particles by mass, to give an SCN material of 100 wt %. In particular embodiments, the SCN material composition of the anode electrode includes approximately 60-0% SCN particles mixed with approximately 40-10% additional carbon-based particles by mass. In certain embodiments, the SCN material composition of the anode electrode includes 5-20% SCN particles mixed with approximately 80-98% additional graphite particles by mass. In yet other embodiments, the SCN material composition of the anode electrode comprises 100% SCN particles.

An SCN material or material composition in accordance with an embodiment of the present disclosure can be referred to as a negative active material, in a manner readily understood by individuals having ordinary skill in the relevant art.

### Representative Structural and Compositional Details of SCN Material Embodiments

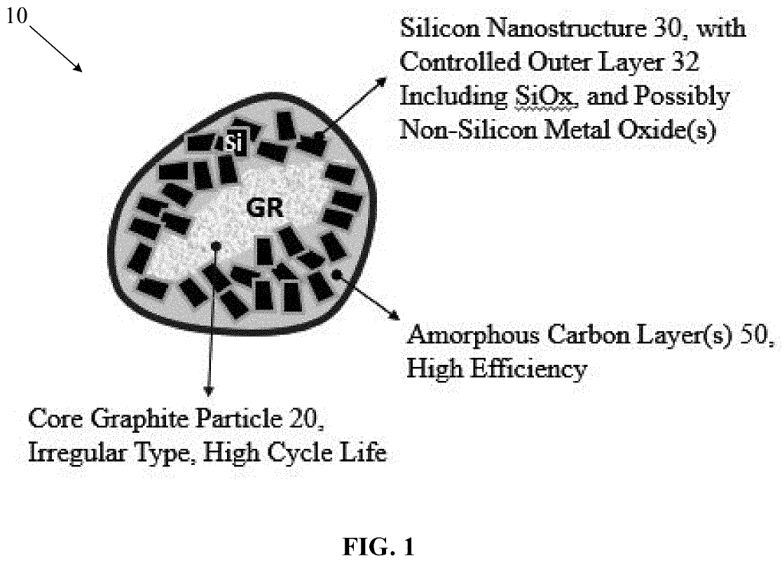

FIG. 1 is a schematic illustration of an SCN particle 10 in accordance with a representative embodiment of the present disclosure. In an embodiment, the SCN particle 10 includes a core graphite particle 20; silicon nanostructures 30 around or surrounding at least portions of the core graphite particle 20; and at least one amorphous carbon layer 50 that at least partially supports, surrounds, or encapsulates the core graphite particle 20 and the silicon nanostructures 30 disposed around the core graphite particle 20. At least some of the silicon nanostructures 30, or essentially all of the silicon nanostructures 30, have an outer layer 32 that includes or contains SiO or SiOₓ (e.g., where 0<x<2), possibly one or more non-silicon metal oxide compounds M_{y}O_{z}, (where M designates a non-silicon metal or metallic element), and/or possibly one or more mixed silicon-non-silicon metal oxide compounds SiₓM_{y}O_{z}. Depending upon embodiment details, in various embodiments SCN particles 10 can exhibit a wt % material composition ratio of: approximately (a) 4-45 wt % of graphite particle cores; (b) approximately 35-76 wt % silicon nanostructures, including at least some silicon nanostructures having an outer layer including SiOₓ; and (c) approximately 15-45 wt % amorphous carbon, wherein the wt % of graphite particle cores, the wt % of silicon nanostructures, and the wt % of amorphous carbon totals to 100%.

In some embodiments, the outer surfaces or layers 32 including the SiOₓ can be doped, modified, and/or transformed in association with or during an SCN particle manufacturing process (e.g., in order to improve initial coulombic efficiency). For instance, the outer layers 32 can be transformed such that the outer layers 32 carry or include at least one type of non-silicon metal oxide compound M_{y}O_{z} and/or at least one type of mixed silicon-non-silicon metal oxide compound SiₓM_{y}O_{z}, depending upon one or more types of metal or metallic element sources used during the SCN particle manufacturing process, wherein M_{y}O_{z} and SiₓM_{y}O_{z} phases can be selected as or selected among Li-inactive or Li-stable oxide materials (e.g., non-silicon and/or mixed silicon-non-silicon metal oxides which are electrochemically inactive or stable with respect to lithiation/delithiation) that are expected to or which can limit, reduce, or suppress undesired or excess formation of SiOₓ on nanoscale silicon particles or silicon nanostructures 30, as further described below.

Depending upon the type(s) of metal source(s) used, SCN particles 10 in accordance with an embodiment of the present disclosure can have a non-SiOₓ oxide content (e.g., an M_{y}O_{z} and/or SiₓM_{y}O_{z} oxide content) between approximately 0.5-10 wt % (e.g., about 3-6 wt %). In embodiments in which SCN particles 10 include oxides therein containing or formed with non-silicon metal elements, a total (silicon oxides plus non-silicon metal oxides plus mixed silicon-non-silicon metal oxides) content of the SCN particles can be less than approximately 10 wt %, or less than approximately 8 wt %. A wt % ratio of (non-silicon metal oxides plus mixed silicon-non-silicon metal oxides) to silicon oxides in the SCN particles 10 can be similar to or lower than the wt % of oxygen in the SCN particles.

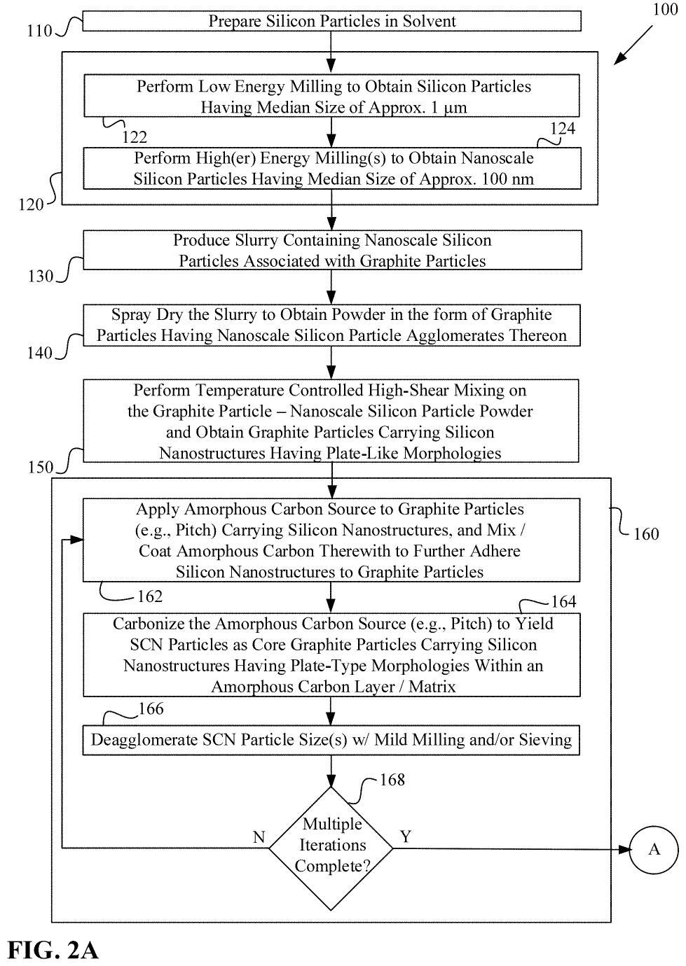

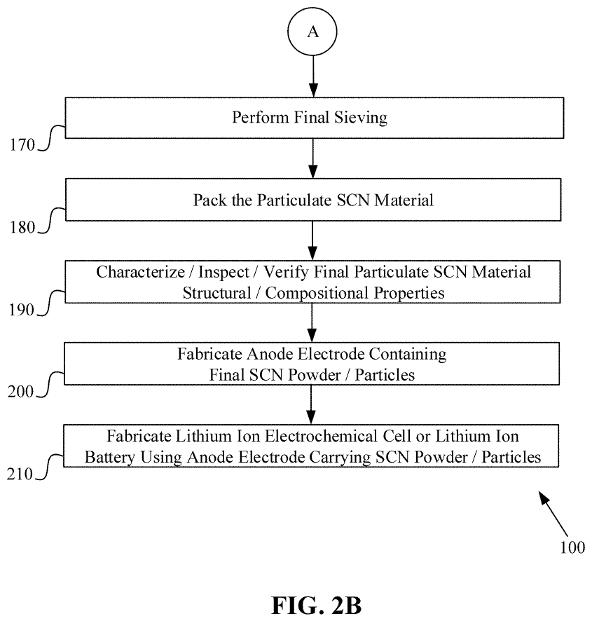

FIGS. 2A-2B are a flow diagram of a process 100 for manufacturing or producing an SCN material composition, a particulate SCN material, or SCN particles; characterizing and testing aspects of the SCN material composition, the particulate SCN material, or SCN particles; and using the SCN material composition, the particulate SCN material, or SCN particles in accordance with certain embodiments of the present disclosure. In an embodiment, the process 100 includes a first process portion 110 involving obtaining, providing, or producing a pre-mixture in which silicon particles are combined and mixed with a solvent, and subjected to an initial or preliminary milling procedure. In the first process portion 110, first/initial or source silicon particles, e.g., a predetermined mass of silicon particles, can be added to a vessel containing a predetermined mass or volume of solvent, after which the silicon particle-solvent mixture can be subjected to the preliminary milling procedure.

In several embodiments, the solvent is isopropyl alcohol (IPA), which reduces or minimizes the likelihood of uncontrolled or excessive silicon particle oxidation; and the mass ratio of solvent:silicon particles can be approximately 2:1. Additional or other solvents can be utilized in specific embodiments, in a manner readily understood by individuals having ordinary skill in the relevant art. The first/initial or source silicon particles can be crystalline silicon particles having a median size (e.g., D50) of approximately 5 micrometers (μm), and/or amorphous silicon particles having a median size of between approximately 2-10 μm. Typically, the silicon particles have a purity of at least approximately 98% and the main impurity is oxidation-related.

The preliminary milling procedure can be directed to producing a homogenous silicon particles slurry, and can be performed by way of a conventional attrition mill or bead mill, e.g., having a bead size of approximately 5.0 millimeters (mm), operating at approximately 1200 revolutions per minute (rpm) for 30 minutes (min.). During or in association with the preliminary milling procedure, the volumetric ratio of solvent:silicon particles can be maintained at approximately 80:20. The first process portion 110, including the preliminary milling procedure, occurs under a moisture-contents-controlled atmosphere in order to reduce uncontrolled or excessive silicon particle oxidation, in a manner readily understood by individuals having ordinary skill in the relevant art.

A second process portion 120 involves subjecting the pre-milled silicon particles in solvent to a set of increased, higher, or high energy milling procedures, to obtain or produce submicron or nanometer scale or nanoscale silicon particles in solvent, for instance, silicon particles having a median particle size (e.g., D50) of approximately 100 nanometers (nm). In multiple embodiments, such high(er) energy mixing and/or milling procedures are performed by way of at least one conventional bead mill. For instance, to increase milling efficiency, second process portion can involve (a) a first high(er) energy bead milling procedure using the milling can include or be performed as two step milling using two different bead-sizes in sequence, e.g., using a first bead size of approximately 0.8-0.4 mm; followed by a second high(er) energy bead milling procedure using a second bead size of approximately 0.05-0.3 mm, where milling can occur at a speed between approximately 1500-2200 rpm, for approximately 4-24 hrs of total milling time. The second process portion 120 also occurs under a moisture-content-controlled atmosphere.

A third process portion 130 involves obtaining or producing a slurry containing nanoscale silicon particles physically associated with or coupled to first, primary, or source graphite particles, e.g., by way of combining and mixing nanoscale silicon particles with graphite particles and a binder under conditions that reduce or minimize uncontrolled or excessive oxidation of the nanoscale silicon particles. In several embodiments, the third process portion 130 involves combining and mixing the nanoscale silicon particles in solvent obtained or produced by way of the second process portion 120 with source graphite particles and a binder, for instance, using a flow dispersion mill.

Depending upon embodiment details, the graphite particles can be synthetic graphite particles (also commonly referred to as artificial graphite particles) and/or natural graphite particles, where the graphite particles typically have a median particle size (e.g., D50) less than approximately 15 um, or between approximately 3-20 μm, e.g., about 6-18 μm. In general, in accordance with embodiments of the present disclosure the graphite particles typically have an average specific surface area between approximately 1.5-8 square meters per gram (m²/g), and in various embodiments the graphite particles have an average specific surface area less than or equal to approximately 3.5 m²/g±1.5. In multiple though not necessarily all embodiments, the graphite particles are artificial or synthetic graphite particles, e.g., artificial graphite particles having a plate-type morphology, without the intentional inclusion or addition of natural graphite particles, e.g., in the absence of natural graphite particles. Individuals having ordinary skill in the art will also recognize that synthetic graphite particles can exist in irregular forms, or mesocarbon microbead (MCMB) graphite particles. Such individuals will also recognize that irregular graphite particles typically exhibit shapes that are at least somewhat more irregular and less spheroidal than MCMB graphite particles. In several embodiments, the synthetic graphite particles are conventional irregular synthetic graphite particles, without the intentional inclusion or addition, or without the presence, of MCMB graphite particles. However, in other embodiments, the synthetic graphite particles are MCMB graphite particles in the absence of irregular synthetic graphite particles; while in still other embodiments, the synthetic graphite particles can be a combination of irregular synthetic graphite particles and MCMB graphite particles.

In the third process portion 130, the binder can include or be polyvinyl alcohol (PVA), and/or another type of binder such as polyvinyl butyral (PVB) resin. In particular embodiments, the mass ratio of nanoscale silicon particles : graphite particles is adjusted to an intended or target ratio for the SCN material, and the binder is added in an amount of approximately 2% by weight of the combined weight of nanoscale silicon particles plus graphite particles. The nanoscale silicon particles in solvent, the graphite particles, and the binder can be mixed in a conventional flow dispersion mill using a circulation gap of approximately 0.3 mm and a rotor spinning speed of approximately 5,000 rpm for about 3 hours at approximately 25° C. to obtain or produce a slurry. Producing the slurry also occurs under a moisture-content-controlled atmosphere. The produced slurry can have a solids content of between approximately 20-40%, e.g., about 30%.

It can be noted that in the third process portion 130, synthetic graphite particles having at least somewhat irregular shapes such as conventional irregular synthetic graphite particles can be used, and/or synthetic graphite particles having generally or approximately spheroidal shapes such as conventional MCMB graphite particles can be used. In multiple though not necessarily all embodiments, the fourth process portion 125 utilizes irregular synthetic graphite particles, in the absence of intentional introduction or addition of MCMB graphite particles.

Further in relation to the foregoing, in some embodiments the process 100 includes the addition or application of a non-silicon metal, metal element, or metal composition source, such as a liquid-based/liquid type non-silicon metal source (e.g., a compound that is liquid at room temperature, and which serves as a source of a non-silicon metal element), to the nanoscale silicon particles. For instance, the third process portion 130 can include the addition of a liquid type non-silicon metal source to the nanoscale silicon particles in solvent obtained or produced by way of the second process portion 120, in association with the addition of the graphite particles and the binder to the nanoscale silicon particles and the mixing thereof. Depending upon embodiment details, a liquid type non-silicon metal source can include or be a liquid type metalorganic compound that exists in liquid form at room temperature, for instance, a metalorganic compound of the form M[OCH(CH₃)₂]ₓ or M(OC₂H₅)ₓ, where M designates a non-silicon metal or metallic element. Thus, the metalorganic compound can include a non-silicon metallic element M as well as a non-zero number of organic radicals, in a manner readily understood by individuals having ordinary skill in the relevant art.

Certain embodiments include an intermediary or additional process portion between the second process portion 120 and the third process portion 130, in which the nanoscale silicon particles in solvent obtained from the second process portion 120 are dried (e.g., under an inert, moisture-controlled atmosphere), and a liquid non-silicon metal solution is then homogeneously coated onto the dried nanoscale silicon particles by way of spray coating/spray drying. The spray-coated nanoscale silicon particles carrying a non-silicon metal element (e.g., on their outer surfaces) are then used as inputs to the third process portion 130.

In embodiments of the process 100 that include the addition of a non-silicon metal source to the nanoscale silicon particles, a milling procedure performed in association with or after the addition of the non-silicon metal source (e.g., milling that occurs during the third process portion 130) can aid the formation and association of non-silicon metal oxide phases and/or mixed silicon-non-silicon metal oxide phases with the outer surfaces of the nanoscale silicon particles. It can be noted that a non-silicon metal carried by the nanoscale silicon particles can be transformed into a non-silicon metal oxide or a mixed silicon-non-silicon metal oxide (e.g., a non-silicon metal oxide or mixed silicon-non-silicon metal oxide layer or coating, which is electrochemically stable or inactive with respect to lithiation-delithiation reactions) by way of heating, such as during a set of carbonization procedures 164 as further described below.

A fourth process portion 140 involves spray drying the slurry produced or obtained by way of the third process portion 130 under an inert or essentially inert atmosphere or environment, such as a nitrogen or argon gas atmosphere, e.g., in which oxygen content is maintained below about 3%. Spray drying can aid or enhance the distribution uniformity or homogeneity of nanoscale silicon particles on, over, or across the outer or exterior surfaces of the graphite particles, reducing the likelihood of undesirable or excess agglomeration/aggregation of nanoscale silicon particles on the graphite particles. In a representative implementation, the spray dryer is conventional, and the slurry is spray dried using nitrogen or argon gas at a temperature between about 80-165° C., a pressure between approximately 1-2 kiloPascals (kPa), and a slurry flow rate of about 15 liters per hour (L/h). Specific spray drying parameters can depend upon the capacity and capabilities of the spray dryer employed, in a manner readily understood by individuals having ordinary skill in the relevant art. For instance, using the aforementioned spray dryer, approximately 6-7 kilograms (kg) of slurry obtained from the fourth process portion 125 and having an initial solids content at the outset of the fifth process portion 130 between about 20-40%, e.g., approximately 30%, can be nitrogen spray dried in accordance with the above spray drying parameters. Following slurry drying, the graphite particles carrying the nanoscale silicon particles are maintained under a moisture-content-controlled atmosphere.

After the slurry has been spray dried, nanoscale silicon particles are disposed or distributed on, over, or across the outer or exterior surfaces of the graphite particles. While at least somewhat or approximately uniform distribution of nanoscale silicon particles over the outer surfaces of the graphite particles is generally intended, this is not required or absolutely required, e.g., at least some agglomerates or aggregates of nanoscale silicon particles can exist on localized regions of the outer surfaces of the graphite particles.

A fifth process portion 150 involves distributing or spreading, or further distributing or spreading, the nanoscale silicon particles across or over the outer surfaces of the graphite particles, and possibly modifying or transforming, or further modifying or transforming, the physical nature or structural characteristics of the nanoscale silicon particles. More particularly, in various embodiments, the fifth process portion 150 involves (a) further distributing or spreading the nanoscale silicon particles across the outer surfaces of the graphite particles, while possibly simultaneously (b) physically modifying or transforming, or further modifying or transforming, the structural characteristics of the nanoscale silicon particles such that many or the majority, nearly all, or essentially all of the nanoscale silicon particles present on the outer surfaces of the graphite particles become modified or transformed, or further modified or transformed, into silicon nanostructures exhibiting plate-like or increasingly plate-like morphologies. Thus, graphite-silicon nanostructure particles are produced by way of the fifth process portion 150, where the silicon nanostructures exhibit plate-like morphologies.

In multiple embodiments, the fifth process portion 150 includes at least one high shear mixing procedure. Shear forces or shear stresses generated (e.g., by way of impact events) during a high shear mixing procedure can modify or transform the geometric profiles or shapes exhibited by the nanoscale silicon particles present on the outer surfaces of the graphite particles following the fourth process portion 140. Additionally, by way of shear forces or shear stresses, the fifth process portion 150 can reduce the presence of or remove pure nanoscale silicon particles, aggregated nanoscale silicon particles, and at least some graphite particle agglomerations present upon completion of the fourth process portion 140. In multiple embodiments, after or upon termination of the fifth process portion 150, many or the majority or nearly or essentially all of the silicon nanostructures carried by the graphite particles exhibit plate-like morphologies.

In a representative implementation, the fifth process portion 150 utilizes a conventional high shear mixer, which can mix the graphite particles on which the agglomerated nanoscale silicon particles reside under high shear conditions in the nitrogen or argon gas atmosphere. The high shear mixing can occur at approximately 2000 rpm for about 15 minutes at a temperature of about 25° C.

Further to the foregoing, in various embodiments the high shear mixing procedure(s) occurs under temperature controlled conditions, i.e., suitably cool(ed) conditions, to avoid over-heating the particles involved, which can give rise to an undesired level of silicon oxidation and an undesired or excessive level of generation of silicon oxide(s). Individuals having ordinary skill in the relevant art will appreciate that the presence of silicon oxide(s) reduce the Coulombic efficiency of Li-ion battery anode material. Therefore, the high shear mixing procedure(s) should occur under appropriate temperature controlled conditions, e.g., cooled conditions at a temperature below approximately 25-40° C. In the aforementioned representative implementation, this was accomplished by cooling the high shear mixer with chilled water during the high shear mixing procedure.

A sixth process portion 160 involves or is directed to physically associating, combining, or fusing graphite-silicon nanostructure particles produced by way of the fifth process portion 150 with amorphous carbon, e.g., including at least partially coating, and typically substantially, essentially entirely, or entirely coating such graphite-silicon nanostructure particles with amorphous carbon; and providing, obtaining, or producing a carbonized layer of amorphous carbon on, around, or overlaying such graphite-silicon nanostructure particles, such that SCN particles are provided, obtained, or produced, in which individual and possibly some agglomerated graphite-silicon nanostructure particles thereof are at least partially embedded, and typically substantially, essentially entirely, or entirely embedded in at least one carbonized layer of amorphous carbon. In various embodiments, the sixth process portion 160 is iteratively or cyclically repeated at least two times, e.g., typically two times, or possibly three or more times depending upon embodiment details to make homogeneous Si nanoparticle layers by suppressing the formation of silicon nanoparticle-pitch carbon agglomeration.

In multiple embodiments, a given iteration of the sixth process portion 160 includes each of (a) an amorphous carbon source application/mixing/coating procedure 162, which is followed by (b) a set of carbonization procedures 164, which is followed by (c) an SCN particle deagglomeration procedure 166. Thus, in such embodiments physical graphite-silicon nanostructure bearing particles that are input to the sixth process portion 160 undergo each of the (a) amorphous carbon source application/mixing/coating procedure 162; (b) the set of carbonization procedures 164; and (c) the SCN particle deagglomeration procedure 166 in a successive, sequential, or serial manner. The SCN particle deagglomeration procedure provides or produces SCN particles, e.g., mostly or nearly entirely individual SCN particles, having sizes that satisfy or meet a particle size criterion, such as a target median particle size (e.g., D50) and/or a target maximum particle size, where such SCN particles serve as the outputs of a given iteration of the sixth process portion 160.

In view of the foregoing, during a first iteration of the sixth process portion 160, the input particles to the sixth process portion 160 are the graphite-silicon nanostructure particles produced in the fifth process portion 150; and upon completion of the first iteration of the sixth process portion 160, the output particles of the sixth process portion 160 are SCN particles satisfying or meeting a first target maximum particle size. During one or more subsequent iterations of the sixth process portion 160, the input particles to the sixth process portion 160 are SCN particles previously or most-recently output by a given prior or most-recent iteration of the sixth process portion 160. Following a last iteration of the sixth process portion 160, SCN particles meeting or satisfying an intended, target, or near-final median particle size (e.g., D50) and/or an intended, target, or near-final maximum particle size serve as the last outputs of the sixth process portion 160. The sixth process portion 160 is performed under an inert or essentially inert atmosphere, e.g., nitrogen or argon gas, in a manner that individuals having ordinary skill in the relevant art will readily understand. Each procedure within the sixth process portion 160 can include a set of sub-procedures, as will also be understood by individuals having ordinary skill in the relevant art based on the description herein.

The amorphous carbon application/mixing/coating procedure 162 involves the introduction, addition, or application of source amorphous carbon material(s) to the graphite-silicon nanostructure bearing particles that serve as inputs to the sixth process portion 160. In multiple embodiments, a source amorphous carbon material includes or is pitch, typically in the form of pitch particles. Thus, during the first iteration of the sixth process portion 160, the amorphous carbon application/mixing/coating procedure 162 involves the addition or application of pitch particles to the graphite-silicon nanostructure particles produced in the fifth process portion 150. The amorphous carbon application/mixing/coating procedure 162 procedure further involves blending/mixing the added pitch particles with the graphite-silicon nanostructure bearing particles most-recently input to the sixth process portion 160, where such blending/mixing can be performed by way of a conventional mixer, typically under non-shear or low-shear conditions, to add, apply, combine, or blend the pitch particles with the graphite-silicon nanostructure bearing particles input to the sixth process portion 160.

After the added amorphous carbon, e.g., pitch particles, and the graphite-silicon nanostructure bearing particles have been blended/mixed, the amorphous carbon application/mixing/coating procedure 162 involves further distributing the amorphous carbon, e.g., pitch particles, over the graphite-silicon nanostructure bearing particles by way of a high temperature coater, such as a rotary furnace (e.g., operating at a temperature of approximately 250° C., under an inert or essentially inert atmosphere such as nitrogen or argon gas), whereby the pitch particles that were mixed with the graphite particles carrying silicon nanostructures are softened and/or melted at a temperature sufficient to remove at least some impurities (e.g., organic matter/volatile organic compounds); and the softened/melted pitch is further distributed (e.g., more uniformly or generally uniformly distributed) over the surfaces of the graphite particles to form a layer of pitch that overlays or surrounds the graphite particles, and within which the silicon nanostructures are surrounded, embedded, encased, or encapsulated. Because the silicon nanostructures are encased in the layer of pitch, the silicon nanostructures are further adhered to the outer surfaces of their underlying graphite particles.

In certain embodiments, the amorphous carbon application/mixing/coating procedure 162 can optionally or alternatively include a kneading procedure, during which pitch-carrying or pitch-bearing particles are kneaded by way of a conventional kneading machine in order to further physically associate, adhere, or bind silicon nanostructures with outer surfaces of the graphite particles, e.g., by way of pitch-enhanced or pitch-based adhesion of the silicon nanostructures to the outer surfaces of graphite particles. In a representative implementation, kneading occurs at approximately 80 rpm rotor speed, at a temperature of approximately 250-350° C. for about 2 hours.

During the kneading procedure, the pitch particles soften or melt, and mechanical kneading causes softened/melted pitch to (further) surround the silicon nanostructures carried on the outer surfaces of the graphite particles, thereby (further) encasing the silicon nanostructures in melted pitch and aiding or furthering adhesion of the silicon nanostructures to the underlying graphite particles. After the kneading procedure, the pitch typically exists as a layer over the at least portions of the outer surfaces of the graphite particles, within which the silicon nanostructures are surrounded, embedded, encased, or encapsulated.

It can be noted that the mass or amount of pitch added to the graphite-silicon nanostructure bearing particles depends upon the surface area and/or amount of silicon nanostructures used in the third process portion 130. More specifically, the mass or amount of pitch particles added as part or in association with a given iteration of the sixth process portion 160 increases with increasing silicon nanostructure amount. However, with respect to the addition of pitch, e.g., pitch particles, it was found that too little overall pitch mass subsequently can give rise to brittle anode material layers, and too much overall pitch mass added for a given single iteration of the sixth process portion 160 can reduce Li-ion battery anode capacity due to low(er) anode capacity and Coulombic efficiency of amorphous carbon formed from pitch (and hence the overall mass of silicon nanostructures needs to increase in order to maintain high anode capacity as the overall mass of pitch increases). Individuals having ordinary skill in the relevant art will understand that the overall pitch mass can be adjusted or varied in view of (a) surface area and/or amount of silicon nanostructures; (b) possibly graphite particle surface area and/or amount; (c) anode structure resiliency/strength; (d) an intended capacity, and possibly (e) the particular iteration of the sixth process portion 160 under consideration.

The set of carbonization procedures 164 involves producing SCN particles by carbonizing the amorphous carbon source material(s), e.g., pitch particles, added/combined/mixed with the graphite-silicon nanostructure bearing particles during the amorphous carbon application/mixing/coating procedure 162. Thus, the output of the carbonization procedure 164 is SCN particles. Carbonization typically involves using a furnace, e.g., a conventional furnace, to heat the graphite-silicon nanostructure bearing particles that were coated with pitch, at a temperature sufficient to generate a solid layer of amorphous carbon on the graphite-silicon nanostructure bearing particles that were coated with pitch, e.g., a furnace temperature between about 700-1100° C., or approximately 900° C. This layer of solidified or solid amorphous carbon at least partially covers the outer surfaces of the underlying graphite particles, and at least some (e.g., the majority, or nearly or essentially all) of the silicon nanostructures surrounding these core graphite particles are embedded or encapsulated within the solid amorphous carbon layer. Some embodiments include a first carbonization (sub-)procedure performed at a first temperature during a first time interval, followed by a second carbonization (sub-)procedure performed at a second temperature during a second time interval (e.g., where the second temperature is higher than the first temperature). The set of carbonization procedures 164 is performed under an inert or essentially inert atmosphere, e.g., nitrogen or argon gas.

In embodiments that included the addition of a non-silicon metal source during the process 100, during the set of carbonization procedures 164, in association with the formation or production of SCN particles, the outer layers 32 of the silicon nanostructures 30 can be converted or transformed such that the outer layers 32 carry or incorporate a non-silicon metal oxide thereon/therein, e.g., such that the outer layers 32 include or carry at least some M_{y}O_{z} and/or SiₓM_{y}O_{z} in addition to carrying at least some SiOₓ. During the set of carbonization procedures 164, the non-silicon metal element(s) carried by the outer surfaces 32 of the silicon nanostructures 30 can be converted to stable non-silicon metal oxides and/or mixed silicon-non-silicon metal oxides, which are electrochemically inactive to lithiation reactions.

A given iteration of the deagglomeration procedure 166 involves controllably obtaining, providing, or producing SCN particles having an intended, target, or specific maximum particle size after the corresponding iteration of the carbonization procedure 164. The deagglomeration procedure 166 typically includes a mild milling procedure (e.g., a low or very low energy milling procedure) followed by a sieving procedure, each of which is performed by way of conventional equipment, in a manner readily understood by individuals having ordinary skill in the relevant art. During the sieving procedure, SCN particles are sieved, such that SCN particles larger than a selected or target or predetermined size, e.g., approximately 40 μm in diameter, are removed or excluded. In some embodiments, each iteration of the sieving procedure utilizes a 400 mesh sieve; however, in other embodiments, successive iterations of the deagglomeration procedure 166 corresponding to different iterations of the sixth process portion 160 can utilize progressively smaller mesh size sieves.

Following the completion of a given iteration of the sixth process portion 160, if another iteration of the sixth process portion 160 is desired or required, the sixth process portion 160 can be repeated using the SCN particles produced or output by a prior and/or the most-recent iteration of the deagglomeration procedure 166. A decision procedure 168, e.g., which can be manual, semi-automated, or automated, can determine whether multiple iterations of the sixth process portion 160 are complete, and no further iterations of the sixth process portion 160 are required. In association with a last iteration of the second process portion 160, a last deagglomeration procedure 160 produces or outputs near-final SCN particles (or possibly final SCN particles) having an intended, target, or near-final particle size distribution, e.g., SCN particles characterized by an intended, target, or near-final median particle size (e.g., D50) and/or an intended, target, or near-final maximum particle size.

After the last iteration of the sixth process portion 160, in various embodiments the SCN particles exhibit an intended, target, or a final material composition or mass ratio of graphite:silicon:amorphous carbon. In multiple embodiments, the target or final graphite:silicon:amorphous carbon ratios are approximately 20-60:35-60:15-30 wt %, for instance, approximately 40:40:20 wt % for a discharge capacity of approximately 1300 mAh/g; approximately 35:45:20 wt % for a discharge capacity of approximately 1400 mAh/g; approximately 30:50:20 wt % for a discharge capacity of approximately 1500 mAh/g; and approximately 25:55:20 wt % for a discharge capacity of approximately 1600 mAh/g, in a manner that includes nonzero amounts of each of these constituents (i.e., graphite, silicon, and amorphous carbon) and which totals to 100% as individuals having ordinary skill in the relevant art will readily understand.

When the amorphous carbon source material(s) include pitch, e.g., pitch particles, in association with a given iteration of the carbonization procedure, organic matter is burned out of the pitch, and the pitch can exhibit a significant mass loss relative to its starting mass, e.g., a mass loss between approximately 20-60 wt %, or approximately 40 wt %, depending upon the specific chemical composition of the pitch used. Depending upon embodiment details, excess pitch particles can be added in a given iteration of the pitch particle application/mixing/coating procedure 162 to account for pitch mass loss during the corresponding iteration of the carbonization procedure 164, such that the near-final SCN particles produced by way of the last iteration of the sixth process portion 160 satisfy an intended or target graphite : silicon : amorphous carbon ratio. In some embodiments in which only two iterations of the sixth process portion 160 are performed, 10 wt % of pitch particles are added as part of the amorphous carbon application/mixing/coating procedure 162 of each such iteration.

In various embodiments, upon completion of a first iteration of the carbonization procedure 164 an SCN particle exists as an inner or core graphite particle or graphite core carrying silicon nanostructures and which has a layer or matrix of amorphous carbon on at least portions of its outer surface, which typically exhibits a thickness ranging between approximately 0.5˜10 um; and after a second or last iteration of the carbonization procedure 164 the amorphous layer or matrix surrounding the core graphite particle carrying silicon nanostructures typically exhibits a thickness ranging between approximately 0.5˜10 um. Thus, after the second or last iteration of the carbonization procedure 164, the carbonized layer(s) of amorphous carbon surrounding a given core graphite particle contains silicon nanostructures embedded or encased and distributed therein. Such layer(s) of solidified/solid amorphous carbon having silicon nanostructures embedded therein exists over at least substantial portions, essentially the entirety, or the entirety of the outer surface(s) of the core graphite particle, and such layer(s) of amorphous carbon and the silicon nanostructures carried therein can partially or significantly fill-in variations in the contours or topography of the outer surface(s) of the graphite particle, e.g., in a somewhat, generally, approximately, or essentially conformal manner. Each successive iteration of the sixth process portion 160 can thus produce SCN particles having solidified/solid amorphous carbon layer(s) that provide(s) improved or more complete coating or conformal covering of the core graphite particles thereof

As indicated above, in several embodiments the near-final SCN particles produced by the last iteration of the sixth process portion 160 have a mass ratio of graphite:silicon:amorphous carbon of approximately 20-60:35-60:15-30 to yield 100% mass with respect to nonzero amounts of each of these components, where the specific graphite:silicon:amorphous carbon mass ratio can vary depending upon embodiment details and/or an intended or target graphite:silicon:amorphous carbon mass ratio. Thus, SCN particles produced in accordance with particular embodiments of the present disclosure can exhibit a mass ratio of carbon : silicon between approximately 40-65:35-60 wt %. Moreover, SCN particles produced in accordance with certain embodiments of the present disclosure can contain approximately 5-10 wt % oxygen (e.g., less than approximately 8 wt % oxygen) by way of Si oxidation. It can be noted that graphite and amorphous carbon in SCN particles cannot be distinguished in a chemical analysis.

With respect to surface coating, modification, and/or transformation of silicon nanostructures within SCN material by way of a set of non-silicon metal or metal element sources, the surface modification can occur by way of the addition of at least one metalorganic compound such as a magnesium methoxide solution, Mg(OCH3)₂, and/or niobium pentaethoxide solution, Nb(OCH2CH3)₅, in a manner indicated above. The metalorganic compound(s) can additionally or alternatively be selected from among one or more of tantalum(V) ethoxide, Ta₂(OC₂H₅)₁₀; titanium tetrapropoxide (TTIP), C₁₂H₂₈O₄Ti; magnesium methyl carbonate, CH₃OMgOCO₂CH₃; diethyl aluminum ethoxide, (C₂H₅)₂AlOC₂H₅; diethyl zinc, (C₂H₅)₂Zn; zirconium(IV) propxide, Zr(OCH₂CH₂CH₃)₄; zirconium(IV) butoxide, Zr(OC₄H₉)₄; zirconium(IV) tert-butoxide, Zr[OC(CH₃)₃]₄; diethyl aluminum ethoxide (C₂H₅)₂AlOC₂H₅; triisobutyl aluminum Al[(CH₃)₂CHCH₂]₃; and other metalorganic compounds (e.g., a copper-containing metalorganic compound, or a cobalt-containing metalorganic compound). In general, the selection of a given metalorganic compound or given set of metalorganic compounds can be guided or determined by whether the use or presence of the given metalorganic compound(s) gives rise to SCN materials, powders, or particles that exhibit improved or significantly improved material properties and/or performance characteristics, such as enhanced ICE. The use of metalorganic compounds that fail to give rise to SCN materials, powders, or particles exhibiting improved or significantly improved material properties and/or performance characteristics can be avoided (e.g., such as the use of various bismuth, indium, tin, and silicon metalorganic compounds, which either do not improve ICE or which give rise to lower ICE). Non-SiOₓ oxide layers or coatings on the outer surfaces of silicon nanostructures (e.g., produced by way of the conversion of non-silicon metalorganic compound(s) to non-silicon metal oxides and/or mixed silicon-non-silicon metal oxides) can remain as oxide phases during lithiation (e.g., as in the case of MgO, Ta₂O₅, Nb₂O₅, or Al₂O₃), or be stable with respect to lithiation and delithiation reactions (e.g., as in the case of TiO₂, CuO, or CoO₂).

In various embodiments, many or the majority, nearly all, or essentially all of the silicon nanostructures within an amorphous carbon layer or matrix exhibit plate-like morphologies. Moreover, after a given carbonization procedure 164, in multiple embodiments silicon nanostructures within a random cross sectional slice or plane through the thickness of the amorphous carbon layer (e.g., for each SCN particle, a random cross sectional slice or plane taken along a direction from the outer surface of the SCN particle toward or to the outer surface of its core graphite particle, such as a direction approximately, nearly, or essentially normal or perpendicular to the outer surface and/or the centroid or center point of the core graphite particle) typically exhibit a median length, which defines their largest physical span or spatial extent, between approximately 50-300 nm, or between approximately 80-160 nm, e.g., approximately 100-140 nm, or approximately 120 nm; a median thickness between about 30-60 nm, e.g., approximately 45 nm; and a median exposed side surface area defined as length multiplied by thickness between approximately 2,400-9,600 nm², or approximately 5,400 nm² (e.g., between approximately 4,000-6,800 nm²). Also, the silicon nanostructures typically internally exhibit grain or nano-grain sizes of between about 7-45 nm, e.g., approximately 10-30 nm.

Upon completion of a given iteration of the sixth process portion 160, or after the last iteration of the sixth process portion 160, in various embodiments the SCN particles typically exhibit a median particle size (e.g., D50) of approximately 10-30 μm, e.g., approximately 15-25 μm. However, individuals having ordinary skill in the relevant art will appreciate that the SCN particle sizes exist within a particle size distribution, e.g., which can include particles larger than 25 μm, depending upon embodiment details.

A seventh process portion 170 can involve subjecting the near-final SCN particles produced or output from the last iteration of the sixth process portion 160 to a final sieving procedure, which can produce, output, or provide final SCN particles having a final median SCN particle size (e.g., D50) and/or a final maximum SCN particle size. An eighth process portion 180 can involve packing the final SCN particles produced by or output from the seventh process portion 170. Such packing can provide or produce a final SCN powder.

A ninth process portion 190 can involve (further) inspecting, characterizing, and/or verifying certain material structural and/or compositional properties of the final SCN particles and/or the packed particulate SCN material or final SCN powder, such as by way of one or more procedures directed to estimating, determining, or measuring such properties by way of (a) median particle size (e.g., D50) measurements; scanning electron microscopy (SEM); focused ion beam scanning electron microscopy (FIB-SEM); transmission electron microscopy (TEM); X-ray diffraction (XRD); and/or one or more other techniques, as will be readily understood by individuals having ordinary skill in the relevant art.

A tenth process portion 200 can involve fabricating an anode or negative electrode structure, which can simply be referred to as an anode, which carries or contains an anode material or material composition or negative active material or material composition which includes, final SCN particles, packed SCN particles, or a final SCN powder produced in accordance with an embodiment of the present disclosure. A final SCN powder can be defined as a powder-form material or material composition that includes SCN particles. Depending upon embodiment details, particulate SCN material can be directly utilized in the anode structure or anode, without combination with additional or secondary graphite particles; or the particulate SCN materials can be combined with additional or secondary graphite particles. In several embodiments, an anode carrying SCN particles in accordance with an embodiment of the present disclosure, in the absence of additional graphite particles blended therewith, provides a capacity of more than 1000 milliAmp hours per gram, (mAhr/g), e.g., more than 1200 mAhr/g or approximately 1250 mAhr/g; and an intrinsic Coulombic efficiency of at least approximately 85%, e.g., about 90%.

In embodiments that include additional graphite particles, the additional graphite particles can be natural and/or synthetic graphite particles, but typically the additional graphite particles include or are synthetic graphite particles. Thus, in some embodiments, the tenth process portion 200 includes a blending procedure in which final SCN particles in powder form are blended with additional graphite particles (e.g., synthetic graphite particles having a median size of approximately 10-30 μm) in accordance with a predetermined final SCN particle : graphite particle mass ratio, for instance, about 3%-25% final SCN particles (e.g., approximately 15% final SCN particles in one embodiment) to correspondingly about 75%-97% additional graphite particles (e.g., approximately 85% additional graphite particles in this specific embodiment), such that the total mass ratio of final SCN particles : additional graphite particles is 100%. In such embodiments, a mass ratio of final SCN particles : additional graphite particles can be approximately 5-25:75-95, e.g., approximately 10-20:80-90, or approximately 15:85.

In the anode, the aforementioned anode material or material composition resides in an anode material layer, in a manner readily understood by individuals having ordinary skill in the relevant art. The anode material layer may further include a binder, and optionally a conductive material. The anode material layer may include about 1 wt % to about 5 wt % of the binder based on the total weight of the anode material layer. In addition, when the anode material layer further includes a conductive material, it may include about 90 wt % to about 98 wt % of the anode material or anode material composition, about 1 wt % to about 5 wt % of the binder, and about 1 wt % to about 5 wt % of the conductive material.

The binder improves the binding properties of the SCN particles and additional graphite particles (if present) to each other and to a current collector. The binder may include a non-water-soluble binder, a water-soluble binder, or a combination thereof.

Nonlimiting representative examples of the non-water-soluble binder include polyvinylchloride, carboxylated polyvinylchloride, polyvinylfluoride, ethylene oxide-containing polymers, polyvinylpyrrolidone, polyurethane, polytetrafluoroethylene, polyvinylidene fluoride, polyethylene, polypropylene, polyamideimide, polyimide, and combinations thereof.

Nonlimiting representative examples of the water-soluble binder include styrene-butadiene rubbers, acrylated styrene-butadiene rubbers, polyvinyl alcohol, sodium polyacrylate, homopolymers or copolymers of propylene and a C2 to C8 olefin, copolymers of (meth)acrylic acid and (meth)acrylic acid alkyl ester, and combinations thereof.

When the water-soluble binder is used as an anode binder, a cellulose-based compound may be further used to provide viscosity. The cellulose-based compound may include one or more of carboxymethyl cellulose, hydroxypropylmethyl cellulose, methyl cellulose, or alkaline metal salts thereof. The alkaline metal may be sodium (Na), potassium (K), or lithium (Li). The cellulose-based compound may be included in an amount of 0.1 to 3 parts by weight based on 100 parts by weight of the binder.

As for the conductive material that may be present in the anode material layer, essentially any electro-conductive material that does not cause a chemical change may be used. Non-limiting representative examples of the conductive material include carbon-based materials (such as natural graphite, artificial graphite, carbon black, acetylene black, ketjen black, carbon fibers, and carbon nanotubes), metal-based materials (such as metal powders or metal fibers including copper, nickel, aluminum, and silver), conductive polymers (such as polyphenylene derivatives), and mixtures thereof.

The current collector may include a copper foil, a nickel foil, a stainless steel foil, a titanium foil, a nickel foam, a copper foam, a polymer substrate coated with a conductive metal, or combinations thereof.

In view of the foregoing, in several embodiments final SCN particles and additional graphite particles can be combined in a conventional liquid carrier to form an anode slurry with about 1-5 wt % of binder based on the total weight of anode active material layer, which can be applied to or coated on a conductive foil (e.g., copper foil), in a manner readily understood by individuals having ordinary skill in the relevant art, thereby forming the anode.

An eleventh process portion 210 can involve fabricating a lithium ion electrochemical cell (e.g., a half cell, a coin cell, or a pouch cell) or a lithium ion battery structure or battery having an anode structure or anode in accordance with an embodiment of the present disclosure (e.g., carrying final SCN particles or a final SCN powder, such as fabricated in association with the tenth process portion 200), and testing or using the electrochemical cell or lithium ion battery. The eleventh process portion 210 can include an electrochemical cell or lithium ion battery fabrication and assembly procedure in which the anode produced by way of the tenth process portion 200 is incorporated into an electrochemical cell or a lithium ion battery, respectively. The electrochemical cell or lithium ion battery includes an electrolyte or electrolyte composition (e.g., a non-aqueous electrolyte, or in certain embodiments an inorganic solid state electrolyte (SSE)) in a manner readily understood by individuals having ordinary skill in the art, and with respect to complete electrochemical cells or lithium ion batteries further includes a cathode or positive electrode structure (e.g., a conventional cathode carrying a cathode material or material composition in a cathode material layer), and a separator structure or separator (e.g., a conventional separator), as also readily understood by individuals having ordinary skill in the relevant art. In several embodiments, an electrochemical cell or lithium ion battery in accordance with an embodiment of the present disclosure has an areal capacity ratio of negative electrode(s) to positive electrode(s) between approximately 1.01-1.10.

An anode that carries particulate final SCN material in accordance with an embodiment of the present disclosure can function with a wide variety of electrolytes or electrolyte compositions suitable for use in lithium ion batteries, a wide variety of cathode structures and cathode materials suitable for use in lithium ion batteries, and a wide variety of separator structures or separators suitable for use in lithium ion batteries. For instance, suitable electrolytes, cathode materials, and separators are disclosed in U.S. Pat. No. 9,876,221, which is incorporated herein by reference in its entirety.

More particularly, a non-aqueous electrolyte may include a non-aqueous organic solvent and a lithium salt. The non-aqueous organic solvent serves as a medium for transmitting ions taking part in the electrochemical reaction of the battery. The non-aqueous organic solvent may include a carbonate-based, ester-based, ether-based, ketone-based, alcohol-based, or aprotic solvent.

Nonlimiting representative examples of carbonate-based solvents include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

Nonlimiting representative examples of ester-based solvents include methyl acetate, ethyl acetate, n-propyl acetate, methylpropionate, ethylpropionate, γ-butyrolactone, decanolide, valerolactone, mevalonolactone, caprolactone, and the like.

Nonlimiting representative examples of ether-based solvents include dibutyl ether, tetraglyme, diglyme, dimethoxyethane, 2-methyltetrahydrofuran, tetrahydrofuran, and the like.

Nonlimiting representative examples of ketone-based solvents include cyclohexanone and the like.

Nonlimiting representative examples of alcohol-based solvents include ethyl alcohol, isopropyl alcohol, and the like.

Nonlimiting representative examples of aprotic solvents include nitriles (such as R—CN where R is a C2 to C20 linear, branched, or cyclic hydrocarbon-based moiety and may include a double bond, an aromatic ring, or an ether bond), amides (such as dimethylformamide), dioxolanes (such as 1,3-dioxolane), sulfolanes, and the like.

A single non-aqueous organic solvent or a mixture of solvents may be used. When the organic solvent is a mixture, the mixture ratio can be adjusted in accordance with intended or target battery performance.

The carbonate-based solvent may include a mixture of a cyclic carbonate and a chain (linear or branched) carbonate. The cyclic carbonate and the chain carbonate may be mixed together in a volume ratio of about 1:1 to about 1:9. When the mixture is used as the non-aqueous organic solvent, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 1.

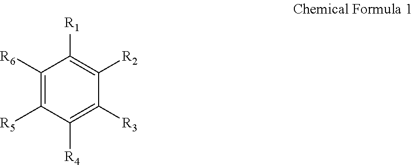

In Chemical Formula 1, each of R₁ to R₆ is independently selected from hydrogen, halogens, C1 to C10 alkyl groups, C1 to C10 haloalkyl groups, and combinations thereof.

Nonlimiting representative examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1 ,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3 ,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The non-aqueous electrolyte may further include a material selected from vinylene carbonate, ethylene carbonate-based compounds of the following Chemical Formula 2, and combinations thereof.

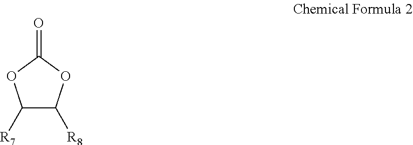

In Chemical Formula 2, R₇ and R₈ are the same or different, and each is independently selected from hydrogen, halogens, cyano groups (CN), nitro groups (NO₂), and C1 to C5 fluoroalkyl groups, provided that at least one of R₇ and R₈ is not hydrogen, i.e., at least one of R₇ and R₈ is selected from halogens, cyano groups (CN), nitro groups (NO₂), and C1 to C5 fluoroalkyl groups.

Nonlimiting representative examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like.

The material selected from vinylene carbonate, ethylene carbonate-based compounds of Chemical Formula 2, and combinations thereof may be included in the electrolyte in an amount of about 15 to about 30 volume % based on the entire amount of the non-aqueous electrolyte solvent.

The lithium salt supplies the lithium ions in the battery, enables the basic operation of the rechargeable lithium battery, and improves lithium ion transport between the positive and negative electrodes. Nonlimiting representative examples of the lithium salt include supporting salts selected from LiPF₆, LiBF₄, LiSbF₆, LiAsF₆, LiN(SO₂C₂F₅)₂, Li(CF₃SO₂)₂N, LiC₂F₅SO₃, LiC₄F₉SO₃, LiClO₄, LiAlO₂, LiAlCl₁₄), LiN(CₓF₂ₓ₊₁SO₂)(C_{y}F_{2y+1}SO₂) (where x and y are natural numbers), LiCl, LiI, LiB(C₂O₄)₂ (lithium bisoxalato borate, LiBOB), and combinations thereof. The lithium salt may be used at a concentration of about 0.1 M to about 2.0 M. When the lithium salt is included at a concentration within this range, electrolyte performance and lithium ion mobility may be enhanced due to optimal electrolyte conductivity and viscosity.

With respect to the cathode material, it may include a lithiated intercalation compound that reversibly intercalates and deintercalates lithium ions. The cathode material may include a composite oxide including at least one selected from cobalt, manganese, and nickel, as well as lithium. In particular, the following compounds may be used:

LiₐA_{1-b}X_{b}D₂ (0.90≤a≤1.8, 0≤b≤0.5)

LiₐA_{1-b}X_{b}O_{2-c}D_{c} (0.90≤a≤1.8, 0≤c≤0.05)

LiₐE_{1-b}X_{b}O_{2-c}D_{c} (0≤b≤0.5, 0≤c≤0.05)

LiₐE_{2-b}X_{b}O_{4-c}D_{c} (0≤b≤0.5, 0≤c≤0.05)

LiₐNi_{1-b-c}CO_{b}X_{c}D_{α} (0.90≤a≤1.8, 0≤b≤0.5, 0≤c≤0.05, 0<α≤2)

LiₐNi_{1-b-c}CO_{b}X_{c}O_{2-α}T_{α} (0.90≤a≤1.8, 0≤b≤0.5, 0≤c≤0.05, 0<α<2)

LiₐNi_{1-b-c}CO_{b}X_{c}O_{2-α}T₂ (0.90≤a≤1.8, 0≤b≤0.5, 0≤c≤0.05, 0<α<2)

LiₐNi_{1-b-c}Mn_{b}X_{c}D_{α} (0.90≤a≤1.8, 0≤b≤0.5, 0≤c≤0.05, 0<α≤2)

LiₐNi_{1-b-c}Mn_{b}X_{c}O_{2-α}T_{α} (0.90≤a≤1.8, 0≤b≤0.5, 0≤c≤0.05, 0<α<2)

LiₐNi_{1-b-c}Mn_{b}X_{c}O_{2-α}T₂ (0.90≤a≤1.8, 0≤b≤0.5, 0≤c≤0.05, 0<α<2)

LiₐNi_{b}E_{c}G_{d}O₂ (0.90≤a≤1.8, 0≤b≤0.9, 0≤c≤0.05, 0.001<d≤0.1)

LiₐNi_{b}Co_{c}Mn_{d}GₑO₂ (0.90≤a≤1.8, 0≤b≤0.9, 0≤c≤0.05, 0≤d≤0.5, 0.001≤e≤0.1)

LiₐNiG_{b}O₂ (0.90≤a≤1.8, 0.001≤b≤0.1); LiₐCoG_{b}O₂ (0.90≤a≤1.8, 0.001≤b≤0.1)

LiₐMn_{1-b}G_{b}O₂ (0.90≤a≤1.8, 0.001≤b≤0.1)

LiₐMn₂G_{b}O₄ (0.90≤a≤1.8, 0.001≤b≤0.1)

LiₐMn_{1-g}G_{g}PO₄ (0.90≤a≤1.8, 0≤b≤0.5)

QO₂

QS₂

LiQS₂

V₂O₅

LiV₂O₅

LiZO₂

LiNiVO₄

Li_{(3-f)}J₂(PO₄)₃ (0≤f≤2)

Li_{(3-f)}Fe₂(PO₄)₃(0≤f≤2)

LiFePO₄

In the above formulas, A may be selected from Ni, Co, Mn, and combinations thereof. X may be selected from Al, Ni, Co, Mn, Cr, Fe, Mg, Sr, V, rare earth elements, and combinations thereof D may be selected from O, F, S, P, and combinations thereof. E may be selected from Co, Mn, and combinations thereof. T may be selected from F, S, P, and combinations thereof. G may be selected from Al, Cr, Mn, Fe, Mg, La, Ce, Sr, V, and combinations thereof. Q may be selected from Ti, Mo, Mn, and combinations thereof Z may be selected from Cr, V, Fe, Sc, Y, and combinations thereof. J may be selected from V, Cr, Mn, Co, Ni, Cu, and combinations thereof.

The lithium-containing compound may have a coating layer on its surface, or may be mixed with another compound having a coating layer. The coating layer may include at least one coating element compound selected from oxides of a coating element, hydroxides of a coating element, oxyhydroxides of a coating element, oxycarbonates of a coating element, and hydroxyl carbonates of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be formed by essentially any process so long as the process does not adversely influence the properties of the cathode material. For example, the process may include any coating method such as spray coating, dipping, and the like.

The cathode material may be present in an amount of about 90 to about 98 wt % based on the total weight of cathode material layer.

The cathode material layer may also include a binder and a conductive material. Each of the binder and the conductive material may be included in an amount of about 1 to about 5 wt % based on the total weight of the cathode material layer.

The binder improves the binding properties of the cathode material particles to each other, and also to the current collector. Nonlimiting representative examples of the binder include polyvinyl alcohol, carboxymethyl cellulose, hydroxypropyl cellulose, diacetyl cellulose, polyvinyl chloride, carboxylated polyvinyl chloride, polyvinylfluoride, ethylene oxide-containing polymers, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, nylon, and the like.

A conductive material may be included in the cathode material layer to improve electrode conductivity. Essentially any electrically conductive material may be used as the conductive material so long as it does not cause a chemical change. Nonlimiting representative examples of the conductive material include natural graphite, artificial graphite, carbon black, acetylene black, ketjen black, carbon fibers, carbon nanotubes, metal powders or metal fibers (including copper, nickel, aluminum, silver, and the like), polyphenylene derivatives, and combinations thereof

The current collector may be aluminum (Al) but is not limited thereto.

A separator may reside between the anode or negative electrode and the cathode or positive electrode, as needed. Nonlimiting representative examples of suitable separator materials include polyethylene, polypropylene, polyvinylidene fluoride, and multi-layers thereof (such as, but not limited to, polyethylene/polypropylene double-layered separators, polyethylene/polypropylene/polyethylene triple-layered separators, and polypropylene/polyethylene/polypropylene triple-layered separators).

In embodiments that are based on an inorganic SSE, the lithium ion battery and the electrolyte thereof can be based on or correspond to a lithium-sulfur (Li-S) battery of a type described in “Progress of the Interface Design in All-Solid-State Li-S Batteries,” Junpei Yue et al., Advanced Functional Materials (www.afm-journal.de), 2018, 28, 1707533 (DOI: 10.1002/adfm.201707533), where the anode material layer or anode electrode thereof carries or contains Si nanostructures in accordance with an embodiment of the present disclosure, e.g., within SCN particles where at least some of the silicon nanostructures exhibit plate-like morphologies in a manner described herein.

### Production and Characterization of Example SCN (ESCN) Particles

Example SCN (ESCN) material including or formed/consisting essentially of ESCN particles were produced in accordance with the process 100 set forth above in FIGS. 2A-2B, using two iterations (i.e., only two iterations) of the sixth process portion 160 (e.g., such that the final ESCN particles had a final graphite:silicon:amorphous carbon ratio as indicated above, for instance, approximately 40:40:20 wt %, or approximately 35:45:20 wt %, or approximately 30:50:20%, or approximately 25:55:20 wt %), and subsequently subjected to or submitted for one or more types of structural and/or compositional analyses, such as described hereafter.

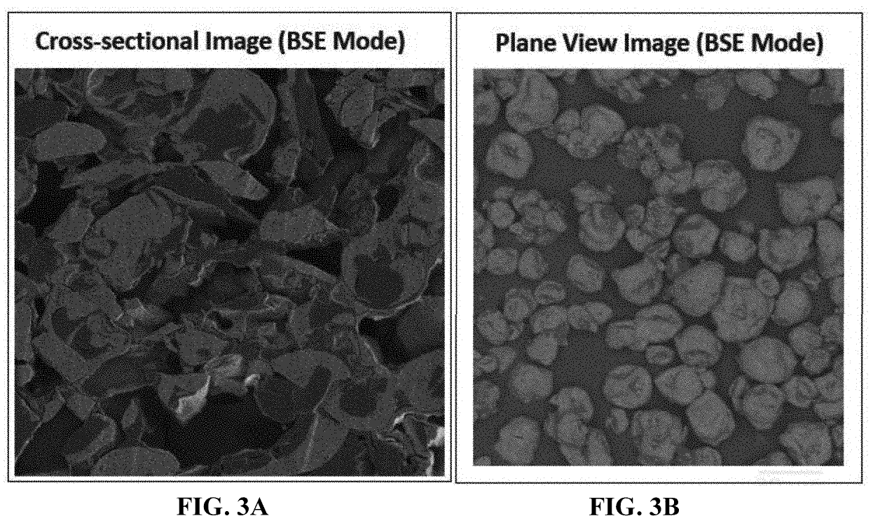

FIGS. 3A and 3B are scanning electron microscope (SEM) photographs taken in backscatter emission (BSE) mode showing a cross-sectional view and a plane view, respectively, of ESCN particles. In the cross-sectional view of FIG. 3A, darker particulate areas correspond to core graphite particles, and lighter particulate areas overlaying, covering, or surrounding the core graphite particles correspond to amorphous carbon layers having silicon nanostructures embedded therein. As indicated in FIG. 3B, the extent and uniformity or homogeneity of amorphous carbon layer coverage of the core graphite particles is generally good to excellent.

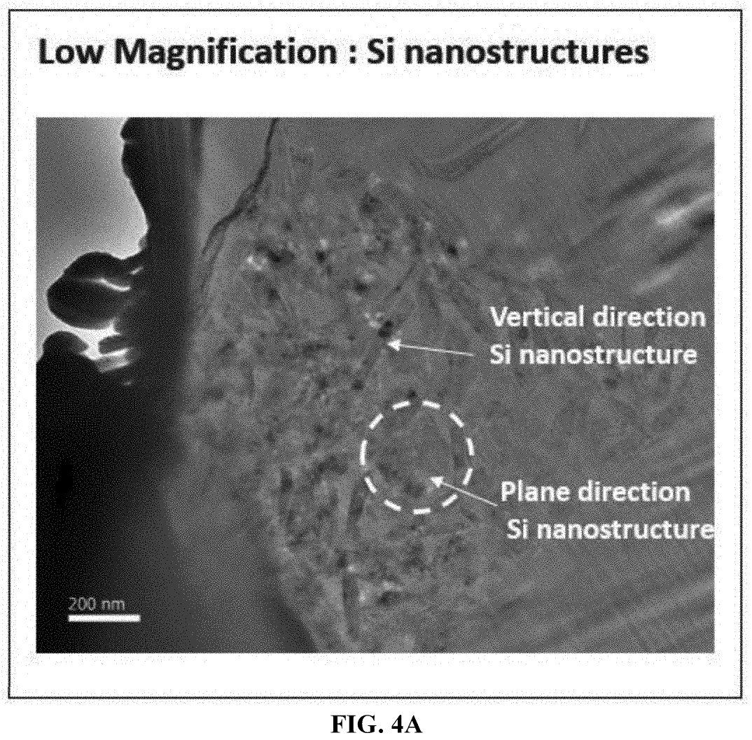

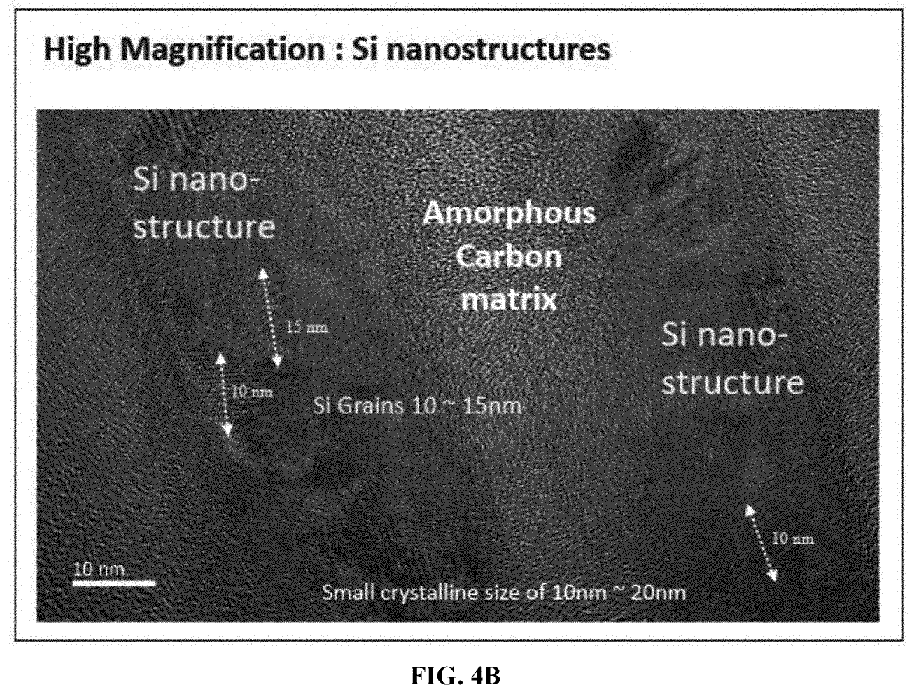

FIGS. 4A and 4B show low magnification and high magnification transmission electron microscopy (TEM) images, respectively, of samples of silicon nanostructures embedded in an amorphous carbon matrix or layer of an ESCN particle. The samples were prepared to a thickness of 50 nanometers (nm) by subjecting them to a Focused Ion Beam (FIB) procedure, in a manner that individuals having ordinary skill in the relevant art will comprehend. As indicated in the low magnification TEM image of FIG. 4A, the silicon nanostructures exhibited plate-like morphologies, as shown by the presence of both on-edge or vertical orientation/direction silicon nanostructures, as well as planar or plane orientation/direction silicon nanostructures. Furthermore, the plate-like morphology silicon nanostructures exhibited a thickness between approximately 30-50 nm, and a length (defined as the largest distance across the silicon nanostructure) between approximately 100-200 nm. Plate-like silicon nanostructure morphologies can reduce the extent of silicon nanostructure swelling and hence the magnitude of corresponding stresses caused by lithiation-delithiation, for instance, such that volumetric changes more readily or more preferentially occur along a certain subset of spatial dimensions, e.g., silicon nanostructure thicknesses, rather than other spatial dimension subsets, e.g., silicon nanostructure lengths and/or widths. As indicated in the high magnification TEM image of FIG. 4B, the silicon nanostructures embedded in the amorphous carbon matrix or layer included, exhibited, or were formed as silicon grain structures, grains, or nano-grains, which typically exhibited a spatial extent or average dimension, e.g., diameter, between approximately 10-50 nm., for instance, between approximately 10-30 nm, e.g., typically about 10-20 nm or 10-15 nm.

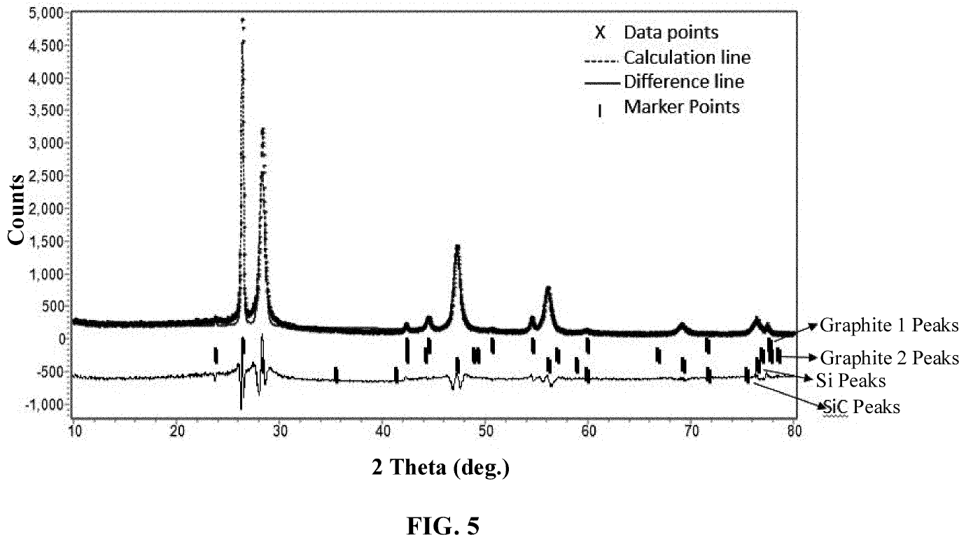

FIG. 5 is a representative X-Ray Diffraction (XRD) Rietveld analysis plot directed to quantitatively characterizing crystalline materials in ESCN particles or material samples produced in accordance with an embodiment of the present disclosure and having approximately 56 wt % silicon and a discharge capacity of approximately 1600 mAh/g. The XRD plot or pattern of FIG. 5 was generated by way of a powder XRD apparatus or device that uses CuKα1 emission x-rays, as individuals having ordinary skill in the relevant art will comprehend. As indicated in the XRD plot or pattern of FIG. 5, the core graphite phase and the silicon phase exhibited sharp peaks. No impurity phases were detected in such ESCN particles.

With respect to FIG. 5, an XRD plot analysis indicated that SCN particles have crystalline material structures therein that exhibit an XRD pattern in which (a) three highest peaks corresponding to silicon (Si) are at positions of 2θ=28.3°±0.5°, 2θ=47.2°±0.5°, 2θ=56.1°±0.5°; and three highest peaks corresponding to graphite are at positions of 2θ=26.4°±0.5°, 2θ=44.5°±0.5°, and 2θ=54.5°±0.5°, as obtained by way of a powder XRD device (Model Rigaku, MiniFlex 600) that uses CuKα1 rays.

Further to the foregoing, various ESCN material samples produced in accordance with embodiments of the present disclosure were analyzed by way of XRD to characterize or determine a ratio of a highest Si XRD peak intensity at 2θ=28.3°±0.5 to a highest graphite XRD peak intensity at 2θ=26.4°±0.5°. More specifically, as indicated in Table 1 below, ESCN material samples identified as ESCN 2-1, ESCN 2-2, ESCN 2-3, ESCN 2-4, ESCN 2-5, ESCN 2-6, ESCN 2-7, and ESCN 2-8 having discharge capacities of approximately 1300, 1400, 1500, 1600, 1700, 1800, 1900, and 2000 mAh/g, respectively (i.e., approximately 1313, 1385, 1508, 1613, 1710, 1820, 1920, 2020 mAh/g, respectively, for the particular embodiments considered in relation to Table 1), were subjected to XRD analyses to determine X-ray peak ratios, i.e., highest integrated Si X-ray peak to highest integrated graphite X-ray peak ratios, therefor.

TABLE 1
Highest Integrated X-Ray Diffraction (XRD) Peak
Intensity Ratios of ESCN Material Samples Having
Discharge Capacities of Approximately 1300, 1400,
1500, 1600, 1700, 1800, 1900, and 2000 mAh/g.

| | | Highest Integrated |
|---|---|---|
| | Discharge | XRD Peak Ratio, |
| ESCN Material | Capacity | Si(111)/Graphite (002), |
| Sample | (mAh/g) | % |
| ESCN 2-1 | 1313 | 0.95 |
| ESCN 2-2 | 1385 | 1.02 |
| ESCN 2-3 | 1508 | 1.30 |
| ESCN 2-4 | 1613 | 1.52 |
| ESCN 2-5 | 1710 | 2.12 |
| ESCN 2-6 | 1820 | 2.71 |
| ESCN 2-7 | 1920 | 4.03 |
| ESCN 2-8 | 2020 | 8.65 |

In relation to the foregoing, individuals having ordinary skill in the relevant art will recognize that XRD is a compositional structure characterization technique for analyzing or characterizing crystalline structures or crystallographic planes (e.g., in the context of the present disclosure, silicon(111) and graphite(002) crystallographic planes) within material samples. Thus, SCN particles or material samples produced in accordance with various embodiments of the present disclosure can be structurally characterized by a ratio of an X-Ray Diffraction (XRD) peak intensity, e.g., a highest integrated peak intensity, corresponding to silicon(111) to an XRD peak intensity, e.g., a highest integrated peak intensity, corresponding to graphite(002) between approximately 0.95-8.65 depending upon embodiment details, such as approximately 0.95-8.65 corresponding to discharge capacities between approximately 1300-2000 mAh/g (e.g., approximately 0.95-2.71 corresponding to discharge capacities between approximately 1300-1800 mAh/g).

Thus, in accordance with various embodiments of the present disclosure, SCN particles have crystalline material structures therein that exhibit an XRD pattern in which a ratio of (a) an XRD peak with a highest integrated intensity corresponding to silicon or Si(111) at a position of 2θ=28.3°±0.5° to (b) an XRD peak with a highest integrated intensity corresponding to graphite or graphite(002) at a position of 2θ=26.4°±0.5° is between approximately 0.95-8.65 per Table 1, as obtained by way of a powder XRD device that uses CuKα1 rays. For instance, ESCN material samples having discharge capacities between approximately 1300-2000 mAh/g exhibited highest integrated XRD peak ratios corresponding to Si(111)/Graphite (002) crystallographic planes between approximately 0.95-8.65.

Beyond the foregoing, ESCN material samples produced in accordance with an embodiment of the present disclosure were also analyzed to characterize or determine their silicon content and oxygen content. For instance, as shown in Table 2 below, portions of ESCN material sample 2-1 contained (a) a silicon content of approximately 33.6 wt %, as determined by way of conventional inductively coupled plasma optical-emission spectroscopy; and (b) an oxygen content of approximately 7.6 wt %, as determined by way of conventional nitrogen-oxygen (NO) analysis (e.g., using a LECO Corp. TC-436DR NO analyzer, LECO Corporation, St. Joseph, Mich. USA).

TABLE 2
Si Content and Oxygen Content of ESCN Material Sample 2-1

| | ESCN | |
|---|---|---|
| | Material | Characterization |
| Chemical Species | Sample 2-1 | Technique |
| Si Content (wt %) | 33.6 | ICP-OES |
| Oxygen Content (wt %) | 7.6 | LECO TC-436DR |

In various embodiments, SCN particles or materials produced in accordance with the present disclosure have an oxygen content less than or equal to approximately 10 wt %, and in several embodiments less than or equal to approximately 8 wt % (e.g., with respect to a 100 wt % total of graphite, silicon, oxygen and carbon in SCN particles, the wt % of oxygen is less than or equal to approximately 8%; or in the case of prelithiated SCN particles, with respect to a 100 wt % total of graphite, silicon, lithium, oxygen and carbon in the prelithiated SCN particles, the wt % of oxygen is less than or equal to approximately 8%).

### Production and Comparative Testing of ESCN-Based and SiOₓ Lithium Ion Coin Half Cells

Half coin cells (e.g., 3-5 per batch of a given ESCN material sample) with SiO/SiOₓ-based anode structures and ESCN-based anode structures and were produced to compare their performance relative to each other.

(1) Half Coin Cells Using Lithium PolyAcrylate (LiPAA) as Binder Material
Sample (a): an SiOₓ-based anode electrode formulation including or consisting essentially of approximately 80 wt % commercially available Mg doped SiOₓ material, approximately 10 wt % added super-P conductive material, and approximately 10 wt % LiPAA solution prepared as LiOH H2O (Sigma-Aldrich) and PAA solution (Mw 250,000, 35 wt % in H2O, Sigma-Aldrich), was formed as a slurry and coated onto a copper sheet to form an SiOₓ-based anode structure, with a loading of 5.0 mg/cm² and a density of 1.4 g/cc.
As shown for Sample (a) in Table 3 below, the SiOₓ-based anode half coin cells using LiPAA as their binder material exhibited a discharge capacity of approximately 1248 mAh/g with a discharge cut-off voltage of approximately 1.5V; and a Coulombic efficiency of approximately 78%.
Sample (b): an ESCN-based anode electrode formulation including or consisting essentially of approximately 80 wt % the ESCN material set forth above, and approximately 10 wt % LiPAA formed as a slurry was coated onto a copper sheet to form an ESCN-based anode structure, with a loading of 5.0 mg/cm² and a density of 1.4 g/cc.
As indicated for Sample (b) in Table 3 below, ESCN-based anode half coin cells using LiPAA as their binder material exhibited a discharge capacity of approximately 1228 mAh/g with a discharge cut-off voltage of approximately 1.5V; and a Coulombic efficiency of approximately 83%.
While the ESCN-based anode half coin cells using LiPAA as their binder material exhibited a generally or moderately similar-discharge capacity than the SiOₓ-based anode half coin cells using the same LiPAA binder material, the ESCN-based anode half coin cells using this LiPAA binder material exhibited a higher Coulombic efficiency than the SiOₓ-based anode half coin cells using this LiPAA binder material.

(2) Half Coin Cells Using High Adhesive Binder (HAB) as Binder Material

SiOₓ-based and ESCN-based half coin cells were also produced using HAB binder material, which includes or is an imide-type binder formulation. The electrode for the coin cell was coated on 8 μm copper foil, and heated to approximately 350° C. in N₂ atmosphere to increase the binding strength of the HAB between Si anode particles.
Sample (c): an SiOₓ-based anode electrode formulation including or consisting essentially of approximately 92 wt % SiO, material and approximately 8 wt % HAB formed as a slurry was coated onto a copper sheet to form an SiOₓ-based anode structure, with a loading of 5.54 mg/cm² and a density of 1.32 g/cc. The electrode for the coin cell was heated to approximately 350° C. in N₂ atmosphere to increase the binding strength of the HAB between the SiOₓ particles.
As shown in Table 3 for Sample (c), on average the SiOₓ-based anode half coin cells using HAB as the binder material exhibited a cut-off voltage of approximately 1.5V; a discharge capacity of approximately 1380 mAh/g with a cut-off voltage of approximately 1.5V; and a Coulombic efficiency of approximately 79%.
Sample (d): an ESCN-based anode electrode formulation including or consisting essentially of approximately 92 wt % the ESCN material set forth above, and approximately 8 wt % HAB material formed as a slurry was coated onto a copper sheet to form an ESCN-based anode structure, with a loading of 5.5 mg/cm² and a density of 1.3 g/cc. The electrode for the coin cell was coated on 8 μm copper foil and heated to approximately 350° C. atmosphere to increase the binding strength of the HAB between the ESCN particles.
As shown in Table 3 for Sample (d), on average the ESCN-based anode half coin cells using HAB binder material exhibited discharge capacity of approximately 1313 mAh/g with a discharge cut-off voltage of approximately 1.5V; and a Coulombic efficiency of approximately 83%.
While the ESCN-based anode half coin cells having as their binder the HAB material a moderately lower discharge capacity than the SiOₓ-based anode half coin cells using HAB as their binder material, the ESCN-based anode half coin cells using HAB as their binder material exhibited a higher Coulombic efficiency than the SiOₓ-based anode half coin cells using this same binder material.
The Coulombic efficiency loss associated with the HAB binder by itself is approximately 8%; thus, the ESCN material by itself is expected to exhibit or provide a Coulombic efficiency of approximately 90%.

TABLE 3
Discharge capacity and Initial Coulombic Efficiency (ICE) of
SiO-based lithium ion coin half cells having an anode structure
formed using Lithium polyacrylate (LiPAA) [SiO-LiPAA]
and high adhesive binder (HAB) [SiO-HAB] as a binder material,
designated Samples (a) and (c), respectively; and discharge
capacity and ICE of ESCN-based lithium ion coin half cells having
an anode structure formed using Lithium polyacrylate (LiPAA)
[ESCN-LiPAA] and high adhesive binder (HAB) [ESCN-HAB]
as a binder material, designated Samples (b) and (d), respectively.

| | Discharge | |
|---|---|---|
| | Capacity | ICE |
| Sample | (mAh/g) | (%) |
| (a) SiO - LiPAA | 1248 | 78 |
| (b) ESCN-LiPAA | 1228 | 83 |
| (c) SiO - HAB | 1380 | 79 |
| (d) ESCN-HAB | 1313 | 83 |

In view of the foregoing, the ESCN-based anode structures considered herein provided good to very good discharge capacity, and excellent Coulombic efficiency. More particularly, the ESCN-based anode structures considered herein exhibited a higher Coulombic efficiency than the SiOₓ-based anode structures considered herein. Individuals having ordinary skill in the relevant art will recognize that Coulombic efficiency is an indicator of lithium ion cell life, or lithium ion battery life. A higher Coulombic efficiency can indicate a reduced extent or rate of anode degradation and is useful for increasing battery energy density or providing a high energy density battery by reducing cathode material amount in the cell with at same anode capacity.

### Cycle Retention and Swelling Behavior of ESCN-Based and SiOₓ Lithium Ion Coin Half Cells

Lithium ion coin half cells having graphite blended SiOₓ-based anode structures and ESCN-based anode structures were formed to compare cycle retention behavior and anode material swelling material behavior between the SiOₓ-based and ESCN-based anode material compositions.

More particularly, SiOₓ material blended with graphite at a SiOₓ: graphite blending ratio of 13:87 wt %, providing a SiOₓ/graphite blending capacity of 480 mAh/g, was combined with a styrene butadiene rubber (SBR)/carboxymethylcellulose (CMC) binder and coated on copper foil sheets (approximately 8 μm thickness) to produce graphite-blended SiOₓ-based lithium ion coin half cells.

Similarly, ESCN material as described above blended with graphite at an ESCN: graphite blending ratio of 14:86 wt %, providing an ESCN/graphite blending capacity of 480 mAh/g, was combined with the same SBR/CMC binder and coated on cooper foil sheets to produce graphite-blended ESCN-based coin half cells.

Coin half cell charge-discharge cycling tests were then carried out on the graphite-blended SiOₓ-based lithium ion coin half cells and the graphite-blended ESCN-based lithium ion coin half cells.

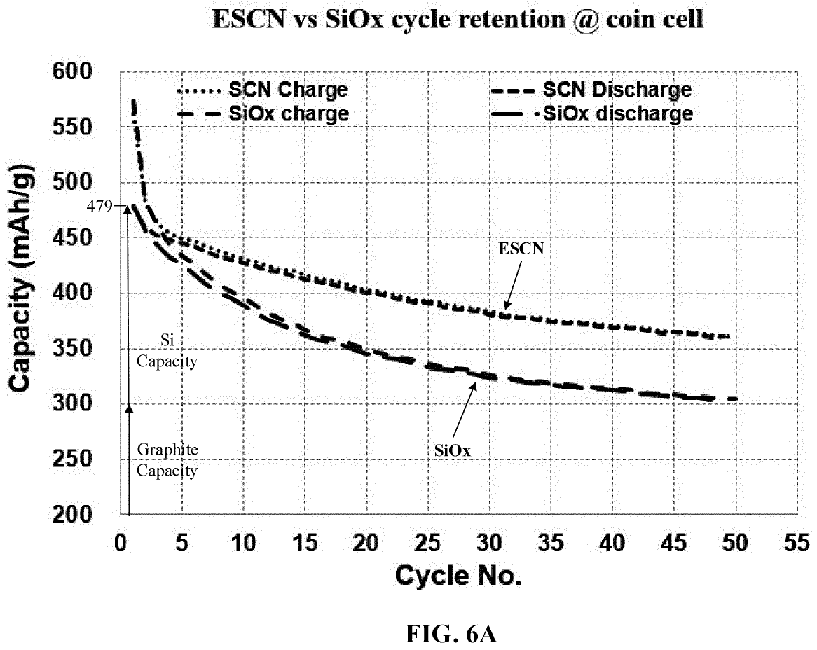

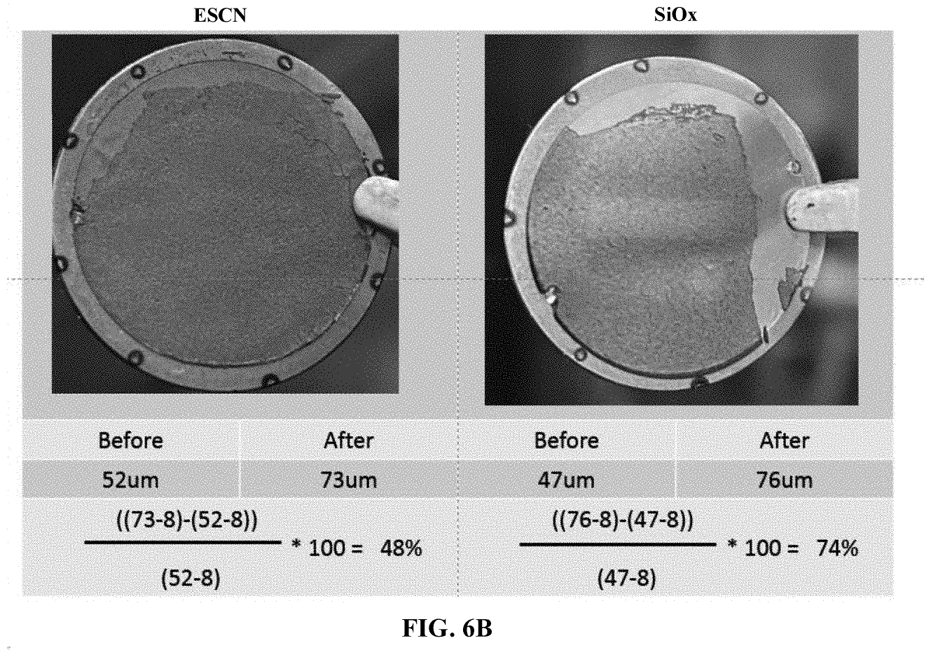

FIG. 6A is a graph showing capacity retention versus charge-discharge cycle number for the graphite-blended SiOₓ-based lithium ion coin half cells and the graphite-blended ESCN-based lithium ion coin half cells, across 49 successively repeated charge-discharge cycles and terminating with a 50th full charge. More particularly, test conditions were as follows, where CC indicates constant current, and CV indicates constant voltage:
1st cycle
Charge: CC/CV mode, 0.1C, 5mV, 0.005C current cut-off, rest: 30min
Discharge: CC mode, 0.1C, 1.5V cut-off, rest: 30min
2nd cycle
Charge: CC/CV mode, 0.1C, 5mV, 0.005C current cut-off, rest: 30min
Discharge: CC mode, 0.1C, 1.0V cut-off, rest: 30min
Cycle Test, 3rd through 49th cycles
Charge: CC/CV mode, 0.5C, 5mV, 0.005C current cut-off, rest: 30min
Discharge: CC mode, 0.5C, 1.0V cut-off, rest: 30min
Full charge, 50th cycle
Charge: CC/CV mode, 0.5C, 5mV, 0.005C current cut-off

As indicated in FIG. 6A, as the number of charge-discharge cycles progressively increased, the graphite-blended ESCN-based lithium ion coin half cells exhibited significantly higher capacity retention than the graphite-blended SiOₓ-based lithium ion coin half cells. The results shown in FIG. 6A are consistent with the enhanced Coulombic efficiency of the ESCN-based anode structures indicated above with respect to Table 3, and further indicate that SCN materials produced in accordance with embodiments with the present disclosure exhibit reduced Si swelling stress by way of the unique nano-composite structure of the SCN particles, and the unique plate-like morphologies of the silicon nanostructures therein.

FIG. 6B shows side-by-side photographs of a disassembled graphite-blended ESCN-based anode structure and a disassembled SiOₓ-based anode structure after the 50th full charging, corresponding to the results shown in FIG. 6A. As clearly indicated in FIG. 6B, the graphite-blended ESCN-based anode structure exhibits little, minimal, or essentially no significant anode structure degradation after 49 successive charge-discharge cycles up to its 50th fully charged state, whereas the graphite-blended SiOₓ-based anode structure exhibits significant or very significant anode structure degradation.

### Representative Pouch Cell Capacity Retention Results

The cathode and anode electrode of 3.5 Amp-hour (Ah) Lithium ion pouch cells were designed to have an energy density of approximately 300 Watt-hours per kilogram (Wh/Kg) on a large cell form factor for an EV pouch cell, with an anode electrode capacity of 430 mAh/g, and a cathode structure having a high loading level of 50 mg/cm² using Nickel-Colbalt-Manganese (NCM) 811 cathode material. Pouch cell dimensions for the capacity retention tests were 10.4 cm width*10.1 cm height*0.28 cm thickness, and this cell structure is of a stacking type. The cell was fabricated by a normal or conventional assembly and formation process.

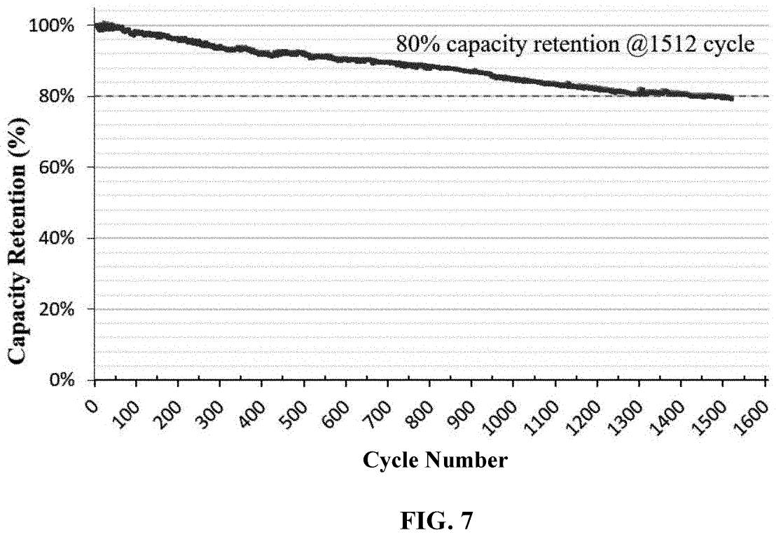

The 3.5 Ah pouch cells were tested for capacity retention across hundreds or many hundreds of charge-discharge cycles. More particularly, FIG. 7 shows a capacity retention cycle life curve across a total of 1512 charge-discharge cycles. At 1500 charge-discharge cycles, the estimated or expected capacity retention was at least approximately 80%. Individuals having ordinary skill in the art will recognize that such capacity retention results are very good to excellent, and indicate that lithium ion battery structures employing anode structures or anodes that utilize SCN material or SCN material compositions in accordance with embodiments of the present disclosure are well-suited for commercial applications.

### Example 1

SCN materials, powders, or particles were prepared in accordance the process 100 described above with reference to FIGS. 2A-2B. Pouch cells were fabricated. The capacities of electrodes fabricated for pouch cells were adjusted to 430 mAh/g by changing blending ratios of graphite particles and SCN powders.

The material composition ratios of Si+SiOₓ: (graphite+amorphous carbon) in the final SCN powders of Example 1 were adjusted to approximately 42:58, 47:53, 52:48, 56:44, 62:38, 67:33, 72:28, and 76:24 to meet approximately 1300,1400, 1500, 1600, 1700, 1800, 1900, and 2000 mAh/g discharge capacities, respectively (i.e., in this particular Example, capacities of 1313, 1385, 1508, 1613, 1710, 1820, 1920, 2020 mAh/g, respectively). For these SCN material compositions, pitch or pitch carbon amounts were adjusted based on the consideration of expected organic material burnout amounts during a set of carbonization procedures 164. For burning out organics in pitch carbon, the mixtures were heated at 800° C. for 1 hr during a first carbonization (sub-)procedure, followed by 900° C. for 1 hr during a second carbonization (sub-)procedure. The highest integrated XRD peak intensity ratios corresponding to Si(111)/Graphite (002), discharge capacity, initial coulombic efficiency (ICE) of coin cells, and the capacity retention of 3.5 Ah pouch cells, are summarized in Table 4 below. Moreover, for comparison purposes, the discharge capacity and ICE for samples of graphite only (e.g., pure graphite) as well as nanoscale silicon particles only (e.g., pure nanoscale silicon particles) are also shown in Table 3.

The capacities increased according to increasing Si content. ICEs were very well-maintained for samples between approximately 1300-1800 mAh/g capacity, and generally well-maintained or acceptably maintained for samples between approximately 1300 to at least approximately 2000 mAh/g capacity.

TABLE 4
Highest Integrated Si(111)/Graphite(002) XRD Peak Intensity, Discharge
Capacity, Initial Coulombic Efficiency (ICE), and Cycle Performance
Corresponding to Representative SCN Material Compositions Having
Different Si:(Graphite + Amorphous Carbon) Ratios Therein.

| Material | Ratio of Highest | | | |
|---|---|---|---|---|
| Composition or | Integrated XRD | | | Cycle |
| Composition Ratio | Peak Intensities, | Discharge | | Number @ |
| (Si + SiOx:Graphite + | Si(111)/Graphite(002) | Capacity | ICE | 80% Capacity |
| Amorphous Carbon) | (%) | (mAh/g) | (%) | Retention |
| Graphite Only | — | 399 | 76 | — |
| 42:58 | 0.95 | 1313 | 83 | 1250 |
| 47:53 | 1.02 | 1385 | 83 | 1220 |
| 52:48 | 1.30 | 1508 | 84 | 1300 |
| 56:44 | 1.52 | 1613 | 84 | 1250 |
| 62:38 | 2.12 | 1710 | 82 | 1300 |
| 67:33 | 2.71 | 1820 | 80 | 1200 |
| 72:28 | 4.03 | 1920 | 79 | 1000 |
| 76:24 | 8.65 | 2020 | 78 | 900 |
| Pure Nanoscale | — | 1412 | 40 | — |
| Silicon Particles* | | | | |

*The electrode formulation of coin cells for pure nanoscale silicon particles was 85(nano Si):10 (HAB):5 (conductive carbon).

### Example 2

SCN materials, powders, or particles were prepared as in Example 1, but with different amorphous carbon amounts, to produce SCN materials, powders, or particles with Si+SiO:graphite:amorphous carbon material composition ratios of approximately 42:38:20, 42:33:25 and 42:28:30. Pouch cells were also fabricated as in Example 1. As indicated in Table 5 below, samples with lower amounts of amorphous carbon demonstrated higher discharge capacity, higher ICE, and better cycle life performance.

TABLE 5
Approximate Discharge Capacity, Initial Coulombic
Efficiency (ICE), and Cycle Performance Corresponding
to Representative SCN Material Compositions Having
Different Amorphous Carbon Contents.

| Material Composition | | | |
|---|---|---|---|
| Ratio, Si + | Discharge | | Cycle Number @ |
| SiOx:Graphite:Amorphous | Capacity | ICE | 80% Capacity |
| Carbon | (mAh/g) | (%) | Retention |
| 42:38:20 | 1313 | 83 | 1250 |
| 42:33:25 | 1250 | 82 | 1150 |
| 42:28:30 | 1210 | 81 | 1100 |

### Example 3, Considered Relative to Comparative Example

SCN materials, powders, or particles were prepared in accordance with the process 100 shown in FIGS. 2A-B, where Comparative Example SCN materials, powders, or particles were produced using only a single iteration of the sixth process portion 160, and Example SCN materials, powders, or particles were produced using two iterations of the sixth process portion 160 (i.e., the sixth process portion 160 was repeated a total of two times). Details of other materials and cell fabrication were the same as in Example 1, with Si+SiOₓ:graphite:amorphous carbon material composition ratios of approximately 42:38:20. Pouch cells were fabricated. The capacities of electrodes fabricated for pouch cells were adjusted to 430 mAh/g by changing the blending ratios of graphite particles and SCN powders.

With respect to discharge capacity and cycle life performance, the Example SCN powders produced using two iterations of the sixth process portion 160 showed better discharge capacity and cycle life performance than the Comparative Example SCN powders produced using only a single iteration of the sixth process portion 160. This indicates that two (or more) iterations of the sixth process portion 160 lead to a more homogenous distribution of silicon nanostructures relative to the amorphous carbon and core graphite particles (e.g., a more uniform distribution of silicon nanostructures around their underlying core graphite particles). For further improvement of cycle life, optimizations of operation parameters were conducted in accordance with Example 1 above. The SCN powders of Example 3, which were produced by way of two iterations of process portion 160, demonstrated good/very good or surprisingly good cycle life when considered relative to the Comparative Example SCN powders, as indicted in Table 6 below.

TABLE 6
Approximate Discharge Capacity, Initial Coulombic Efficiency
(ICE), and Cycle Performance Corresponding to SCN
Material Compositions Produced with a Single Iteration
or Two Iterations of Process Portion 160.

| | Discharge | | Cycle Number @ |
|---|---|---|---|
| | Capacity | ICE | 80% Capacity |
| Sample | (mAh/g) | (%) | Retention |
| Comparative Example - | 1248 | 79 | 800 |
| Single Iteration of Process | | | |
| Portion 160 | | | |
| Example 5 - Two Iterations | 1313 | 83 | 1250 |
| of Process Portion 160 | | | |
| Example 5 - Two Iterations | 1315 | 83 | 1500 |
| of Process Portion 160, | | | |
| with Further Optimization | | | |

### Example 4

SCN materials, powders, or particles were prepared as in Example 1, but with the addition of different metalorganic compound solutions, namely, magnesium methoxide, [Mg(OCH₃)₂], or niobium pentaethoxide, [Nb(OCH₂CH₃)₅], to produce stable non-silicon metal oxide layers or coatings and/or mixed silicon-non-silicon metal oxide layers on the outer surfaces of silicon nanostructures in SCN materials by adding these metalorganic compounds in association with or as part of process portion 130. The ratio of Si:graphite:amorphous carbon in the samples with added metalorganic compounds were controlled to meet a capacity of 1500 mAh/g. Mg(OCH₃)₂ and Nb(OCH₂CH₃)₅ metalorganic compounds were transformed to Mg-containing oxides (e.g., MgO) and Nb-containing oxides (e.g., Nb₂O₅), respectively, by way of a set of carbonization procedures 164, such that silicon nanostructures in the SCN materials, powders, or particles carried Mg-containing oxides and Niobium-containing oxides, respectively, in their outer layers (e.g., in addition to SiOₓ). Individuals having ordinary skill in the relevant art will understand that such Mg-containing oxides (e.g., MgO) and niobium-containing oxides (e.g., Nb₂O₅) are electrochemically inactive phases during lithiation. During heat-treatment (e.g., by way of the set of carbonization procedures 164), Mg-containing oxides (e.g., MgO) and niobium-containing oxides (Nb₂O₅) can be more easily or preferentially formed than SiOₓ because the Mg-containing oxides and the Nb-containing oxides are more thermodynamically stable phases than SiOₓ (e.g., SiO₂). The role of a non-silicon metal oxide layer or coating and/or a mixed silicon-non-silicon oxide layer or coating on silicon nanostructures is to limit, reduce, or suppress the further oxidation of silicon nanostructures to SiOₓ phases, and decrease the side reaction(s) with Li metal during the charge and discharge of full cells, thereby leading to improved or high(er) ICE and better cycle life. As indicated in Table 7 below, samples having metalorganic compounds added thereto demonstrated higher discharge capacity, higher ICE, and better cycle life performance. Consequently, the formation or presence of non-silicon metal oxide layers or coatings and/or mixed silicon-non-silicon oxide layers or coatings on silicon nanostructures of SCN materials, powders, or particles, such as by way of the addition of a metalorganic compound to nanoscale silicon particles and the thermal generation of non-silicon metal oxide layers or coatings and/or mixed silicon-non-silicon oxide layers or coatings on silicon nanostructures, can be effective to improve the ICE of anode materials and the cycle life (e.g., capacity retention) of full cells.

TABLE 7
Approximate Discharge Capacity, Initial Coulombic Efficiency (ICE),
and Cycle Performance Corresponding to Representative SCN Material
Compositions Having Different Metalorganic Compounds.

| | Discharge | | Cycle Number @ |
|---|---|---|---|
| Metalorganic | Capacity | ICE | 80% Capacity |
| Compound | (mAh/g) | (%) | Retention |
| None | 1508 | 84 | 1300 |
| Mg(OCH3)₂ | 1510 | 86 | 1500 |
| Nb(OCH2CH3)₅ | 1502 | 85 | 1450 |

In general, in a process directed to manufacturing a negative electrode active material that includes or which is formed using nanoscale silicon particles/materials, whether the negative electrode active material includes core graphite particles (e.g., wherein such nanoscale silicon particles at least partially surround, overlay, or cover the core graphite particles) or the negative electrode active material excludes core graphite particles: (a) under a controlled atmosphere, one or more non-silicon metalorganic compounds can be added or applied to, coated on, or combined with nanoscale silicon particles that themselves were produced under a controlled atmosphere which limited, reduced, or minimized the formation or presence of SiOₓ on the nanoscale silicon particles; and (b) the nanoscale silicon particles carrying the non-silicon metalorganic compound(s) can subsequently be subjected to a set of thermal procedures or heat treatments (e.g., in a furnace or oven, either under a controlled inert (e.g., N₂ or Ar gas) atmosphere or under atmospheric air) to preferentially, selectively, or controllably generate at least some (i) non-silicon metal oxide(s), M_{y}O_{z}, and/or (ii) mixed silicon-non-silicon metal oxide(s), SiₓM_{y}O_{z}, on the outer surfaces of the nanoscale silicon particles rather than entirely or only generating SiOₓ on the outer surfaces of the nanoscale silicon particles. In such a negative electrode active material, the presence of at least some of such non-silicon metal oxide(s), M_{y}O_{z}, and/or mixed silicon-non-silicon metal oxide(s), SiₓM_{y}O_{z}, on the outer surfaces of nanoscale silicon particles or silicon nanostructures (e.g., instead of only SiOₓ) can aid or enhance the ICE of the negative electrode active material and/or the cycle life (e.g., cycle stability/capacity retention) of a lithium secondary cell that includes a set of electrode structures carrying the negative electrode active material.

### Example 5

SCN materials, powders, or particles were prepared as in Example 1, but with different graphite particle sizes. Pouch cells were also fabricated as in Example 1. As indicated in Table 8 below, samples with lower amounts of amorphous carbon demonstrated higher discharge capacity, higher ICE, and better cycle life performance. Larger graphite particle size shows lower ICE and anode material capacity, and poorer cycle life performance of pouch cells.

TABLE 8
Approximate Discharge Capacity, Initial Coulombic
Efficiency (ICE), and Cycle Performance Corresponding
to Representative SCN Material Compositions Having
Different Amorphous Carbon Contents.

| Graphite | Discharge | | Cycle Number @ |
|---|---|---|---|
| particle size | Capacity | ICE | 80% Capacity |
| (D50) (um) | (mAh/g) | (%) | Retention |
| 25 | 1450 | 79 | 600 |
| 18 | 1500 | 83 | 1200 |
| 13 | 1508 | 84 | 1300 |
| 6 | 1560 | 85 | 1400 |

In view of the foregoing, in various embodiments the graphite particle cores in SCN material compositions, powders, or particles are artificial graphite particles having a plate-type morphology and a median particle size of approximately 6-18 micrometers (μm) or less.

The above description details aspects of processes, compositions, structures, and devices in accordance with particular non-limiting representative embodiments of the present disclosure. It will be readily understood by a person having ordinary skill in the relevant art that modifications can be made to one or more aspects or portions of these and related embodiments without departing from the scope of the present disclosure, which is limited only by the following claims.

1. A silicon-carbon nanocomposite (SCN) material composition comprising SCN particles, including SCN particles that each comprise:
a graphite particle core having an irregular morphology characterized by a plurality of outer surfaces including a plate-type outer surface;
a plurality of silicon nanostructures distributed around the irregular morphology graphite particle core, including silicon nanostructures exhibiting plate-like morphologies and which have an outer layer that includes SiOₓ; and
an amorphous carbon layer or matrix that encapsulates the silicon nanostructures and at least portions of the irregular morphology graphite particle core.

2. The SCN material composition of claim 1, wherein the SCN particles have crystalline material structures therein that exhibit an X-ray diffraction (XRD) pattern in which:
(a) three highest peaks corresponding to silicon are at positions of 2θ=28.3°±0.5°, 2θ=47.2°±0.5°, 2θ=56.1°±0.5°; and
(b) three highest peaks corresponding to graphite are at positions of 2θ=26.4°±0.5°, 2θ=44.5°±0.5°, and 2θ=54.5°±0.5°, as obtained by way of a powder XRD device that uses CuKα1 rays.

3. The SCN material composition of claim 1, wherein the SCN particles have crystalline material structures therein that exhibit an X-ray diffraction (XRD) pattern in which a ratio of (a) an XRD peak with a highest integrated intensity corresponding to silicon at a position of 2θ=28.3°±0.5° to (b) an XRD peak with a highest integrated intensity corresponding to graphite at a position of 2θ=26.4°±0.5° is between approximately 0.95-8.65, as obtained by way of a powder XRD device that uses CuKα1 rays.

4. The SCN material composition of claim 3, wherein the SCN particles have crystalline material structures therein that exhibit an XRD pattern in which a ratio of (a) an XRD peak with a highest integrated intensity corresponding to silicon at a position of 2θ=28.3°±0.5° to (b) an XRD peak with a highest integrated intensity corresponding to graphite at a position of 2θ=26.4°±0.5° is between approximately 0.95-8.65, and wherein the SCN particles have a discharge capacity between approximately 1300-2000 milliamp-hours per gram (mAh/g).

5. The SCN material composition of claim 1, wherein the SCN particles exhibit a wt % material composition ratio of:
(a) 4˜45 wt %-of graphite particle cores;
(b) 35˜76 wt % silicon nanostructures, including at least some silicon nanostructures having an outer layer including SiOₓ; and
(c) 15˜45 wt % amorphous carbon,
wherein the wt % of graphite particle cores, the wt % of silicon nanostructures, and the wt % of
amorphous carbon totals to 100%.

6. The SCN material composition of claim 5, wherein the SCN particles including silicon nanostructures have outer oxide layers comprising SiOₓ, and which collectively provide the SCN material composition with an oxygen content less than or equal to 10 wt %.

7. The SCN material composition of claim 5, wherein the outer oxide layers further comprise a non-silicon metal oxide compound of the form M_{y}O_{z} and/or a mixed silicon-non-silicon metal oxide compound of the form SiₓM_{y}O_{z.}

8. The SCN material composition of claim 1, wherein the graphite particle cores within the SCN material composition have an average specific surface area between 1.5-8 square meters per gram (m²/g).

9. The SCN material composition of claim 7, wherein the graphite particle cores within the SCN material composition have an average specific surface area less than or equal to 3.5 m²/g±1.5.

10. The SCN material composition of claim 1, wherein the graphite particle cores in the SCN material composition are artificial graphite particles having a plate-type morphology and a median particle size of 6-18 micrometers (μm) or less.

11. The SCN material composition of claim 1, wherein for each silicon nanostructure exhibiting a plate-like morphology:
(a) the silicon nanostructure has a median particle size D50 between approximately 50-300 nanometers (nm);
(b) with respect to three orthogonal axes relative to which the silicon nanostructure is positioned or aligned:
a first axis extends along a largest or longest physical span or spatial extent of the silicon nanostructure that establishes the silicon nanostructure's length;
a second axis orthogonal to the first axis extends along a next largest physical span or spatial extent of the silicon nanostructure that establishes the silicon nanostructure's width; and
a third axis orthogonal to the first and second axes extends along a smallest physical span or spatial extent of the silicon nanostructure that establishes the silicon nanostructure's thickness;
and
(c) a mean aspect ratio of each silicon nanostructure defined by a ratio of the thickness of the silicon nanostructure to the length of the silicon nanostructure within a cross sectional plane through the amorphous carbon layer or matrix is between 0.20-0.60.

12. The SCN material composition of claim 10, wherein the silicon nanostructures are comprised of nanosilicon grains exhibiting an average size or diameter of 10-50 nm.

13. A lithium ion (Li-ion) battery structure comprising an anode electrode carrying the SCN material composition of claim 1.

14. The Li-ion battery structure of claim 13, further comprising:
a cathode electrode;
a liquid or solid state electrolyte; and
a pouch, prismatic, or cylindrical structure in which the anode electrode, the cathode electrode, and the electrolyte reside.

15. The Li-ion battery structure of claim 13, wherein the SCN material of the anode electrode comprises approximately 3-50 wt % SCN particles mixed with approximately 50-97 wt % additional graphite particles by mass, to give an SCN material of 100 wt %.

16. The Li-ion battery structure of claim 13, wherein the SCN material of the anode electrode comprises 5-20% SCN particles mixed with approximately 80-98% additional graphite particles by mass.

17. The Li-ion battery structure of claim 13, wherein the SCN material of the anode electrode comprises 100% SCN particles.

18. The Li-ion battery structure of claim 13, wherein the SCN material of the anode electrode comprises approximately 60-90% SCN particles mixed with approximately 40-10% additional carbon-based particles by mass.

19. A method for producing a particulate silicon-carbon nanocomposite (SCN) material, comprising:
providing or producing a first powder comprising primary graphite particles having nanoscale silicon particles on outer surfaces thereof;
subjecting the first powder to a temperature-controlled high shear mixing procedure to produce a second powder comprising primary graphite particles carrying silicon nanostructures distributed on the outer surfaces thereof, wherein the silicon nanostructures include a multiplicity of silicon nanostructures having plate-like morphologies; and
performing at least two iterations of:
distributing a source of amorphous carbon over or across the primary graphite particles carrying silicon nanostructures in the second powder;
performing a set of carbonization procedures upon the primary graphite particles carrying silicon nanostructures in the second powder and having the source of amorphous carbon distributed thereover or thereacross to produce SCN particles; and
deagglomerating the SCN particles produced by way of the set of carbonization procedures to produce SCN particles having particle sizes that satisfy or meet a particle size criterion.

20. The method of claim 19, wherein the source of amorphous carbon comprises pitch.

21. The method of claim 19, wherein the source of amorphous carbon comprises solid pitch particles.

22. The method of claim 19, wherein providing or producing the first powder comprises:
producing or providing nanoscale silicon particles;
applying a non-silicon metalorganic compound to the nanoscale silicon particles; and
combining the nanoscale silicon particles to which the non-silicon metalorganic compound has been applied with the primary graphite particles.

23. The method of claim 22, further comprising transforming the non-silicon metalorganic compound to a non-silicon metal oxide composition and/or a mixed silicon-non-silicon metal oxide compound by way of the set of carbonization procedures.

24. The method of claim 19, wherein the set of carbonization procedures is performed at a temperature between 700-1000° C. in a furnace.

25. The method of claim 19, wherein the set of carbonization procedures comprises a first carbonization procedure performed at a first temperature during a first time interval, followed by a second carbonization procedure performed at a second temperature higher than the first temperature during a second time interval.

26. A method for producing a negative electrode active material, comprising:
providing nanoscale silicon particles that were produced under a controlled atmosphere which limited the formation of SiOₓ on the outer surfaces of the nanoscale silicon particles;
applying a non-silicon metalorganic compound containing a non-silicon metal element M to outer surfaces of the nanoscale silicon particles;
associating the nanoscale silicon particles carrying the non-silicon metalorganic compound on their outer surfaces with a carbon source; and
subjecting the nanoscale silicon particles carrying the non-silicon metalorganic compound on their outer surfaces and associated with the carbon source to a set of thermal procedures by which the non-silicon metalorganic compound is converted to a non-silicon metal oxide, M_{y}O_{z}, and/or a mixed silicon-non-silicon metal oxide, SiₓM_{y}O_{Z}, on the outer surfaces of the nanoscale silicon particles.

27. The method of claim 26, further comprising producing a negative electrode structure including the nanoscale silicon particles carrying the non-silicon metal oxide, M_{y}O_{z}, and/or the mixed silicon-non-silicon metal oxide, Si_{X}M_{y}O_{z}, on their outer surfaces.
